(19) United States
(12) Patent Application Publication
(10) Pub. No.: US 2023/0281353 A1
(43) Pub. Date: Sep. 7, 2023

(54) USER ELEMENT TECHNIQUE FOR ENABLING COARSE-MODE/HIGH-FIDELITY COMPUTER-AIDED ENGINEERING DURABILITY EVALUATION OF SPOT-JOINED STRUCTURES

(71) Applicant: THE REGENTS OF THE UNIVERSITY OF MICHIGAN, Ann Arbor, MI (US)

(72) Inventors: Lunyu ZHANG, Ann Arbor, MI (US); Shengjia WU, Ann Arbor, MI (US); Pingsha DONG, Ann Arbor, MI (US)

(21) Appl. No.: 18/175,756

(22) Filed: Feb. 28, 2023

Related U.S. Application Data
(60) Provisional application No. 63/315,189, filed on Mar. 1, 2022.

(51) Int. Cl. G06F 30/17

(52) U.S. Cl. CPC G06F 30/17; G06F 2119/04

(57) ABSTRACT

A method for modeling joints using User Element (UEL) techniques by analytically eliminating a series of internal degrees of freedom for representing actual weld or joint stiffness in structures. The resulting formulation is in closed-forms enabling computational accuracy and simplicity for structural applications. For spot joint, the detailed ring type of finite elements required to achieve a reasonable accuracy can be replaced by a simple finite element mesh using just four user elements. The UEL joint modeling method offers accurate stress calculation results by comparing with the mesh-insensitive structural stress method coupled with a detailed explicit joint representation of joints. The UEL method can also be applied for modeling seam welded joints, e.g., MIG, laser, and friction stir welds. The explicit representation of weld fillet geometry required by existing methods is no longer needed by the UEL plate/shell elements without losing any accuracy.

### CROSS-REFERENCE TO RELATED APPLICATIONS

This application claims the benefit of U.S. Provisional Application No. 63/315,189 filed on Mar. 1, 2022. The entire disclosure of the above application is incorporated herein by reference.

### FIELD

The present disclosure relates to spot-jointed (or welded, including seam welded) structures and, more particularly, relates to a user element technique for enabling coarse-model/high-fidelity Computer-Aided Engineering (CAE) durability evaluation of such structures.

### BACKGROUND AND SUMMARY

This section provides background information related to the present disclosure which is not necessarily prior art. This section provides a general summary of the disclosure, and is not a comprehensive disclosure of its full scope or all of its features.

In most of vehicular structures, there exist thousands of spot welds or other type of joints (including mechanically fastened, e.g., self-piercing riveters, laser or arc welded spot or seam joints). These joints are severe stress raiser sites that are prone to fatigue damage under time-varying operational loads and pose major challenges in new vehicle development. Durability testing at both component and vehicle levels are time- and cost-prohibitive in today's competitive environment.

To ensure structural durability in rapid prototyping, a reliable joint modeling method becomes essential for both determining joint positions/spacing at the design stage and minimizing physical testing required for ensuring vehicle durability, often referred to as Computer-Aided Engineering (CAE) or CAE durability simulation or modeling.

Currently, existing CAE modeling techniques, by means of commercial finite element (FE) software packages, either suffer mesh-size and mesh-type sensitivity in stress computation around joints or require explicit representation of a joint geometry (even with the most advanced method to date). Available joint modeling scenarios are either too complicated and time-consuming for use in complex structures (e.g., containing thousands of spot joints in a typical passenger car and about 7000 in a commercial vehicle cab structure, or too simple to produce reliable results. As a result, uncertainties inherent in the over-simplified joint modeling approach require both exhaustive testing at various vehicle development stages, often resulting in using a lot more joints than actually necessary.

Therefore, according to the principles of the present teachings, a method is provided for modeling joints using a “User Element” (UEL) technique. In the case of spot joint modeling, a “user-element” (UEL) modeling of the present teachings has been developed through a rigorous analytical formulation by eliminating a series of internal degrees of freedom for representing actual weld or joint stiffness in structures. As a result, the detailed ring type of finite elements can be replaced by a simple finite element mesh using just four user elements for representing a spot joint, as an example. For typical body-in-white structures containing many spot connections, the use of UELs can lead to at least 10 times saving in modeling generation cost. In addition to significantly simplified modeling requirements, the UEL joint modeling method offers accurate stress calculation results by comparing with the mesh-insensitive structural stress method coupled with a detailed explicit joint representation of joints versus the method used today.

In the case of seam-welded joint modeling, the UEL method of the present teachings can also be applied for modeling seam welded joints, e.g., MIG, laser, and friction stir welds. The explicit representation of weld fillet geometry can be represented by the simple UEL plate/shell elements.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of a spot joint by four “user elements” (UEL) on each of two sheets according to the principles of the present disclosure;

FIGS. 2A and 2B are schematic illustrations of an existing explicit spot joint modeling technique by VERITY™ method available in one of the commercial durability software. Note that other available methods using the joint presentation shown but without conventional elements are not capable of producing credible stress results, e.g., LBF method;

FIG. 3 is a comparison of the virtual node of a conventional 36×36 K matrix of the existing explicit spot joint modeling technique using the present coarse-mesh/high fidelity computer aided design durability evaluation versus a virtual node of an analytically reduced 24×24 K matrix by imposing spot joint constraints according to the principles of the present disclosure;

FIG. 4 is an illustration of a virtual nodes 1, 2 and 5 of the K^{m} matrix by imposing membrane joint constraints 7-1, 7-2, 7-5 according to the principles of the present disclosure;

FIG. 5 is a schematic view of the implementation of the UEL in finite element software;

FIG. 6 is an illustration of an example ABAQUS™ user subroutine interface according to the principles of the present disclosure;

FIG. 7A is an illustration of a component containing two spot welds modeled according to an existing direct method, e.g., VERITY™;

FIG. 7B is an illustration of a component containing two spot welds modeled according to a UEL method;

FIG. 8 is a first comparison graph of the stress per unit load vs angle (degree) around a spot weld edge according to a direct stress test method, the UEL method according to the principles of the present disclosure and a conventional “LBF” method used in various commercial structural durability software packages, which also allows a simple joint representation, but lacks the accuracy required;

FIG. 9A is an illustration of a component containing two spot joints under lap shear loading according to a direct method, e.g., VERITY™;

FIG. 9B is an illustration of a component with two spot joints in lap shear specimens according to a UEL method;

FIG. 10 is a second comparison graph of the stress concentration factor (SCF) vs angle (degree) of the lap shear specimens according to a direct stress test method, the UEL method according to the principles of the present disclosure and a conventional “LBF” method used in commercial structural durability software packages;

FIG. 11A (left) is a schematic three dimensional (3D) representation of a seam welded component using UEL's from an existing explicit weld modeling technique in which the 3D fillet weld (with a triangle-shaped cross-section) in today's structural durability simulations software; FIG. 11A (right) is a schematic representation of the same 3D component using the UELs for which only plate or shell elements are needed without losing any accuracy;

FIG. 11B (left) is a representation of the Finite Element Model using solid elements with explicit fillet weld representation; FIG. 11B (right) is a representation of Finite Element Model using UEL enabling simple representation of fillet weld with the same computational accuracy;

FIG. 12 is a schematic illustration of an existing explicit T-joint seam weld modeling technique for representing an actual 3d plate fillet welded component in structures;

FIG. 13 (left) is a schematic representation of Finite Element Model using solid elements with explicit fillet weld representation. FIG. 13 (right) is a schematic representation of a T-joint seam weld modeling using UELs in which not only 3D fillet weld needs not to be modeled, but also simple shell or plate elements are all that is needed;

FIG. 14A is an illustration of the actual nodes (5 and 6) of a conventional seam weld joint modeling technique with two plate elements in existing structural durability software;

FIG. 14B is an illustration of how the two actual nodes in FIG. 14A are eliminated in UEL by imposing seam joint membrane constraints through two virtual nodes in the UEL formulation according to the principles of the present disclosure;

FIG. 15A is an illustration of a lap filet weld joint according to a UEL method;

FIG. 15B is an illustration of a lap filet weld joint according to a conventional method;

FIG. 16A is a two-element representation of T-filet weld joint according to a UEL method which is a side view of FIG. 13B;

FIG. 16B is a three-element representation of a T-filet weld joint according to a conventional method which is a side view of FIG. 13A;

FIG. 17 is an illustration of an arbitrary shaped 4-node element according to the UEL method for representing a spot in complex structures;

FIG. 18 is a comparison bar graph of the of the stress concentration factor (SCF) of the T-fillet-welded component according to a conventional method and according to a UEL method according to the principles of the present disclosure;

FIG. 19 is a validation bar graph of the of the maximum stresses calculated for the T-fillet-welded component according to a conventional method, according to a coarse model with the UEL method according to the principles of the present disclosure and with a coarse model without the UEL method;

FIG. 20 is a graph demonstrating fatigue life predictability with structural stress range (MPa) vs. Life (cycles) with the UEL-base coarse mesh finite element modeling;

FIG. 21 is a graph demonstrating fatigue life predictability with nominal stress range (MPa) vs. Life (cycles) for the conventional modeling method;

FIG. 22 is a graph demonstrating fatigue life predictability in dissimilar material welds e.g. aluminum to steel with structural stress range (MPa) vs. Life (cycles) for the UEL coarse mesh finite element modeling; and

FIG. 23 is a graph demonstrating fatigue life predictability in dissimilar material welds e.g. aluminum to steel with structural stress range (MPa) vs. Life (cycles) for the conventional modeling method.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

1. Spot Joint Modeling

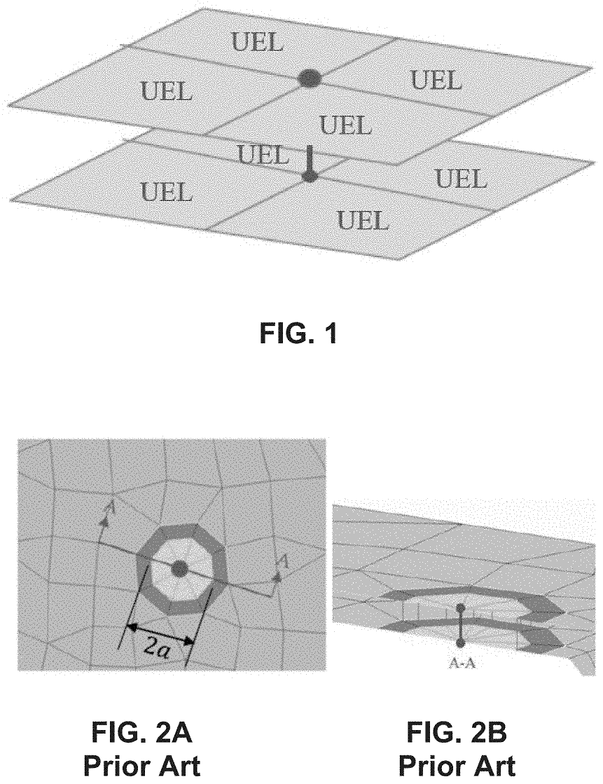

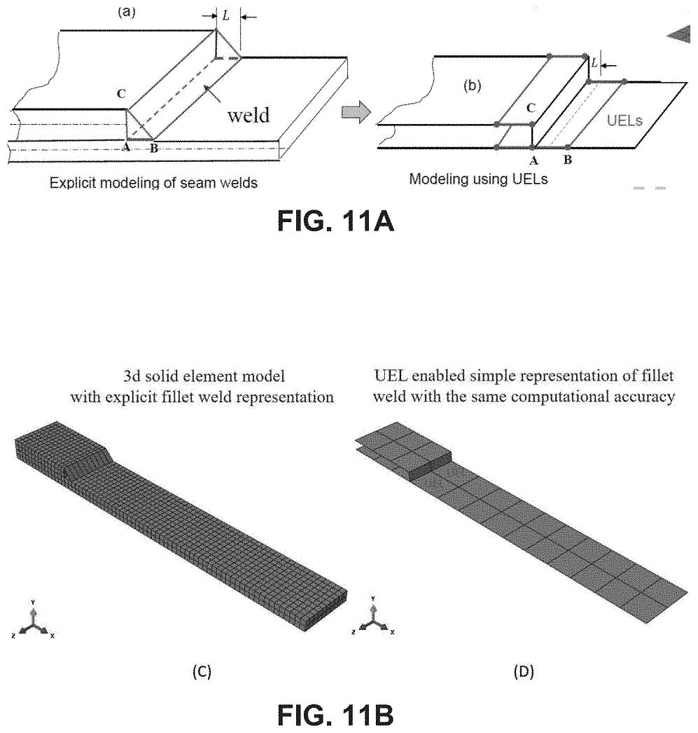

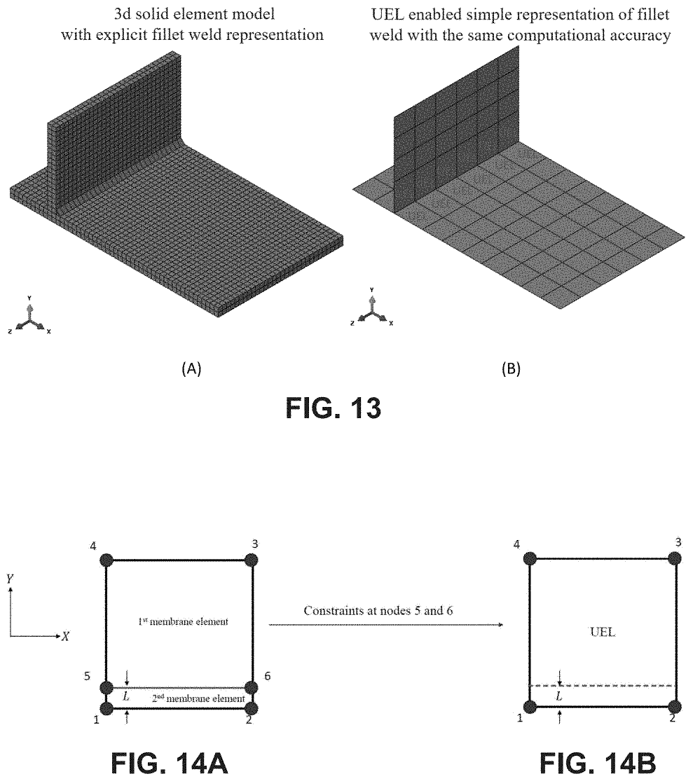

A “user-element” (UEL) has been developed through a rigorous formulation by eliminating a series of internal degrees of freedom at virtual nodes, which represent actual weld or joint stiffness in a vehicle body structure. The welds that are modeled can be welds that connect components such as, but not limited to, front rails, side rails, rear rails, floor components, firewall components, floor cross members, roof cross members, A pillars, B pillars and other body components. The resulting UEL joint representation in complex structures becomes as simple as shown in FIG. 1 or FIG. 11A (right) or FIG. 13B with a simplified UEL joint connecting between two plates.

FIGS. 2A and 2B are two illustrations of a spot joint representation (FIG. 2A shows top plate view and FIG. 2B is the cross-section cut view for cross-section A-A as denoted in FIG. 2A) using an existing explicit spot joint modeling technique in today's commercial-available structural durability software, e.g., VERITY™ for spot joints between two plates.

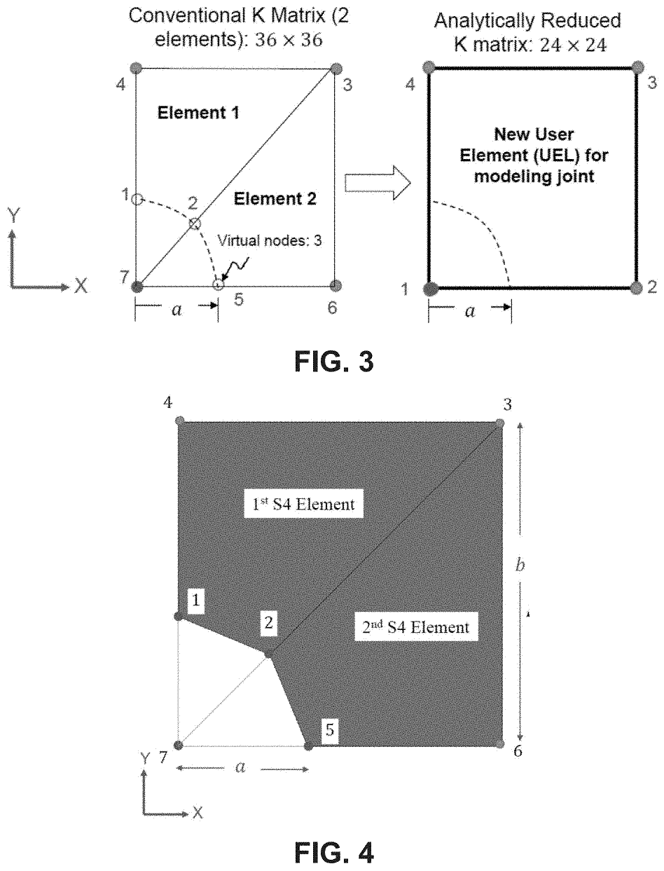

FIG. 3 is a schematic illustration for developing the UEL for modeling a quarter of a spot weld. The actual nodes 1, 2 and 5 in the conventional 36×36 K matrix of the existing explicit spot joint modeling technique using the present coarse-mesh/high fidelity computer aided design durability evaluation are replaced as virtual nodes (left) such that the internal degrees of freedom at virtual nodes can be eliminated and lead to an analytically reduced 24×24 K matrix by imposing spot joint constraints shown as the dashed line according to the principles of the present disclosure (right).

With reference to FIGS. 3 and 4, the analytical process for producing the UEL formulation will now be described. The UEL formulation includes imposing spot joint constraints at virtual nodes (1, 2 and 5). The shell/plate elements in commercial finite element codes such as ABAQUS include a combination of membrane K^{m} and plate K^{b} element stiffness (K) matrices. The plate membrane element has two degrees of freedom at each node, i.e., u, v, where u, v, and w represent displacement along X, Y and Z direction. The plate bending element has three degrees of freedom at each node, i.e., w, θₓ, θ_{y}, where θₓ, θ_{y} represent rotation along X and Y directions. The coordinates of the nodes 1, 2, 3, and 4 in this example are:

$$Node 1 : ( {x}_{1} , {y}_{1} ) = ( 0 , a )$$

$$Node 2 : ( {x}_{2} , {y}_{2} ) = ( \frac{\sqrt{2} a}{2} , \frac{\sqrt{2} a}{2} )$$

$$Node 3 : ( {x}_{3} , {y}_{3} ) = ( b , b )$$

$$Node 4 : ( {x}_{4} , {y}_{4} ) = ( 0 , b ) ,$$

where a=the joint weld nugget radius and b=element size.

The UEL formulation further includes imposing membrane joint constraints in the equations:

$${K}^{m} U = F \qquad ( 1 )$$

$${K}^{m} [ \begin{matrix}{u}_{1} \\ {v}_{1} \\ {u}_{2} \\ {v}_{2} \\ {u}_{3} \\ {v}_{3} \\ {u}_{4} \\ {v}_{4} \\ {u}_{5} \\ {v}_{5} \\ {u}_{6} \\ {v}_{6}\end{matrix} ] = {u}_{1} [ \begin{matrix}{F}_{x 1} \\ {F}_{y 1} \\ {F}_{x 2} \\ {F}_{y 2} \\ {F}_{x 3} \\ {F}_{y 3} \\ {F}_{x 4} \\ {F}_{y 4} \\ {F}_{x 5} \\ {F}_{y 5} \\ {F}_{x 6} \\ {F}_{y 6}\end{matrix} ] \qquad ( 2 )$$

where uᵢ, vᵢ, are the displacements along the X and Y directions at node i, and Fₓᵢ, F_{yi} are the forces along X and Y directions at node i.

The membrane joint constraints applied include rigid kinematic relationships:

u₁=u₂=u₅=u₇

v₁=v₂=v₅=v₇

And force equilibrium equations:

Fₓ₇=Fₓ₁+Fₓ₂+Fₓ₅ (3)

F_{y7}=F_{y1}+F_{y2}+F_{y5} (4)

The UEL formulation results in K^{m} being a 12×12 matrix. The additional drilling degree θ_{z} of freedom is added for numerical stability.

With the imposition of the membrane joint constraints the UEL formulation provides two shell elements (e.g., “S4” in ABAQUS) Part 1.

The displacement vector is denoted as:

$$U = [ \begin{matrix}{u}_{1} \\ {v}_{1} \\ {u}_{2} \\ {v}_{2} \\ {u}_{3} \\ {v}_{3} \\ {u}_{4} \\ {v}_{4} \\ {u}_{5} \\ {v}_{5} \\ {u}_{6} \\ {v}_{6}\end{matrix} ] \qquad ( 5 )$$

$${K}^{m} = {\sum }_{1}^{2} {M}^{T} {K}_{e}^{m} M$$

Then for the 1^{st} S4 shell element:

$${U}^{1} = [ \begin{matrix}{u}_{1} \\ {v}_{1} \\ {u}_{2} \\ {v}_{2} \\ {u}_{3} \\ {v}_{3} \\ {u}_{4} \\ {v}_{4}\end{matrix} ] = [ \begin{matrix}1 & 0 & 0 & 0 & 0 & 0 & 0 & 0 & 0 & 0 & 0 & 0 \\ 0 & 1 & 0 & 0 & 0 & 0 & 0 & 0 & 0 & 0 & 0 & 0 \\ 0 & 0 & 1 & 0 & 0 & 0 & 0 & 0 & 0 & 0 & 0 & 0 \\ 0 & 0 & 0 & 1 & 0 & 0 & 0 & 0 & 0 & 0 & 0 & 0 \\ 0 & 0 & 0 & 0 & 1 & 0 & 0 & 0 & 0 & 0 & 0 & 0 \\ 0 & 0 & 0 & 0 & 0 & 1 & 0 & 0 & 0 & 0 & 0 & 0 \\ 0 & 0 & 0 & 0 & 0 & 0 & 1 & 0 & 0 & 0 & 0 & 0 \\ 0 & 0 & 0 & 0 & 0 & 0 & 0 & 1 & 0 & 0 & 0 & 0\end{matrix} ] U \qquad ( 6 )$$

for the 2^{nd} S4 shell element:

$${U}^{2} = [ \begin{matrix}{u}_{5} \\ {v}_{5} \\ {u}_{6} \\ {v}_{6} \\ {u}_{3} \\ {v}_{3} \\ {u}_{2} \\ {v}_{2}\end{matrix} ] = [ \begin{matrix}0 & 0 & 0 & 0 & 0 & 0 & 0 & 0 & 1 & 0 & 0 & 0 \\ 0 & 0 & 0 & 0 & 0 & 0 & 0 & 0 & 0 & 1 & 0 & 0 \\ 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 1 \\ 0 & 0 & 0 & 0 & 1 & 0 & 0 & 0 & 0 & 0 & 0 & 0 \\ 0 & 0 & 0 & 0 & 0 & 1 & 0 & 0 & 0 & 0 & 0 & 0 \\ 0 & 0 & 1 & 0 & 0 & 0 & 0 & 0 & 0 & 0 & 0 & 0 \\ 0 & 0 & 0 & 1 & 0 & 0 & 0 & 0 & 0 & 0 & 0 & 0\end{matrix} ] U \qquad ( 7 )$$

The above calculations for stiffness matrix assembly results in the following formulation equations:

K₁₁u₁+K₁₂v₁+K₁₃u₂+K₁₄v₂+K₁₅u₃+K₁₆v₃+K₁₇u₄+K₁₈v₄+K₁₉u₅+K_{1,10}v₅+K_{1,11}u₆+K_{1,12}v₆=Fₓ₁ (8)

K₂₁u₁+K₂₂v₁+K₂₃u₂+K₂₄v₂+K₂₅₇₁₃+K₂₆v₃+K₂₇u₄+K₂₈v₄+K₂₉u₅+K_{2,10}v₅+K_{2,11}u₆+K_{2,12}v₆=F_{y1} (9)

K₃₁u₁+K₃₂v₁+K₃₃u₂+K₃₄v₂+K₃₅u₃+K₃₆v₃+K₃₇u₄+K₃₈v₄+K₃₉u₅+K_{3,10}v₅+K_{3,11}u₆+K_{3,12}v₆=Fₓ₂ (10)

K₄₁u₁+K₄₂v₁+K₄₃u₂+K₄₄v₂+K₄₅u₃+K₄₆v₃+K₄₇u₄+K₄₈v₄+K₄₉U₅+K_{4,10}v₅+K_{4,11}u₆+K_{4,12}v₆=F_{y2} (11)

K₅₁u₁+K₅₂v₁+K₅₃u₂+K₅₄v₂+K₅₅u₃+K₅₆v₃+K₅₇u₄+K₅₈v₄+K₅₉u₅+K_{5,10}v₅+K_{5,11}u₆+K_{5,12}v₆=Fₓ₃ (12)

K₆₁u₁+K₆₂v₁+K₆₃u₂+K₆₄v₂+K₆₅u₃+K₆₆v₃+K₆₇u₄+K₆₈v₄+K₆₉u₅+K_{6,10}v₅+K_{6,11}u₆+K_{6,12}v₆=F_{y3} (13)

K₇₁u₁+K₇₂v₁+K₇₃u₂+K₇₄v₂+K₇₅u₃+K₇₆v₃+K₇₇u₄+K₇₈v₄+K₇₉u₅+K_{7,10}v₅+K_{7,11}u₆+K_{7,12}v₆=Fₓ₄ (14)

K₈₁u₁+K₈₂v₁+K₈₃u₂+K₈₄v₂+K₈₅u₃+K₈₆v₃+K₈₇u₄+K₈₈v₄+K₈₉u₅+K_{8,10}v₅+K_{8,11}u₆+K_{8,12}v₆=F_{y4} (15)

K₉₁u₁+K₉₂v₁+K₉₃u₂+K₉₄v₂+K₉₅u₃+K₉₆v₃+K₉₇u₄+K₉₈v₄+K₉₉u₅+K_{9,10}v₅+K_{9,11}u₆+K_{9,12}v₆=Fₓ₅ (16)

K_{10,1}u₁+K_{10,2}v₁+K_{10,3}u₂+K_{10,4}v₂+K_{10,5}u₃+K_{10,6}v₃+K_{10,7}u₄+K_{10,8}v₄+K_{10,9}u₅+K_{10,10}v₅+K_{10,11}u₆+K_{10,12}v₆=F_{y5} (17)

K_{11,1}u₁+K_{11,2}v₁+K_{11,3}u₂+K_{11,4}v₂+K_{11,5}u₃+K_{11,6}v₃+K_{11,7}u₄+K_{11,8}v₄+K_{11,9}u₅+K_{11,10}v₅+K_{11,11}u₆+K_{11,12}v₆=Fₓ₆ (18)

K_{12,12}u₁+K_{12,2}v₁+K_{12,3}u₂+K_{12,4}v₂+K_{12,5}u₃+K_{12,6}v₃+K_{12,7}u₄+K_{12,8}v₄+K_{12,9}u₅+K_{12,10}v₅+K_{12,11}u₆+K_{12,12}v₆=F_{y6} (19)

Which, with the rigid kinematic equations u₁=u₂=u₅=u₇ and v₁=v₂=v₅=v₇ imposed results in the following joint membrane constraint equations:

(K₁₁+K₁₃+K₁₉)u₇+(K₁₂+K₁₄+K_{1,10})v₇+K₁₅u₃+K₁₆v₃+K₁₇u₄+K₁₈v₄+K_{1,11}u₆+K_{1,12}v₆=Fₓ₁ (20)

(K₂₁+K₂₃+K₂₉)u₇+(K₂₂+K₂₄+K_{2,10})v₇+K₂₅u₃+K₂₆v₃+K₂₇u₄+K₂₈v₄+K_{2,11}u₆+K_{2,12}v₆=F_{y1} (21)

(K₃₁+K₃₃+K₃₉)u₇+(K₃₂+K₃₄+K_{3,10})v₇+K₃₅u₃+K₃₆v₃+K₃₇u₄+K₃₈v₄+K_{3,11}u₆+K_{3,12}v₆=Fₓ₂ (22)

(K₄₁+K₄₃+K₄₉)u₇+(K₄₂+K₄₄+K_{4,10})v₇+K₄₅u₃+K₄₆v₃+K₄₇u₄+K₄₈v₄+K_{4,11}u₆+K_{4,12}v₆=F_{y2} (23)

(K₅₁+K₅₃+K₅₉)u₇+(K₅₂+K₅₄+K_{5,10})v₇+K₅₅u₃+K₅₆v₃+K₅₇u₄+K₅₈v₄+K_{5,11}u₆+K_{5,12}v₆=Fₓ₃ (24)

(K₆₁+K₆₃+K₆₉)u₇+(K₆₂+K₆₄+K_{6,10})v₇+K₆₅u₃+K₆₆v₃+K₆₇u₄+K₆₈v₄+K_{6,11}u₆+K_{6,12}v₆=F_{y3} (25)

(K₇₁+K₇₃+K₇₉)u₇+(K₇₂+K₇₄+K_{7,10})v₇+K₇₅u₃+K₇₆v₃+K₇₇u₄+K₇₈v₄+K_{7,11}u₆+K_{7,12}v₆=Fₓ₄ (26)

(K₈₁+K₈₃+K₈₉)u₇+(K₈₂+K₈₄+K_{8,10})v₇+K₈₅u₃+K₈₆v₃+K₈₇u₄+K₈₈v₄+K_{8,11}u₆+K_{8,12}v₆=F_{y4} (27)

(K₉₁+K₉₃+K₉₉)u₇+(K₉₂+K₉₄+K_{9,10})v₇+K₉₅u₃+K₉₆v₃+K₉₇u₄+K₉₈v₄+K_{9,11}u₆+K_{9,12}v₆=Fₓ₅ (28)

(K_{10,1}+K_{10,3}+K_{10,9})u₇+(K_{10,2}+K_{10,4}+K_{10,10})v₇+K_{10,5}u₃+K_{10,6}v₃+K_{10,7}u₄+K_{10,8}v₄+K_{10,11}u₆+K_{10,12}v₆=F_{y5} (29)

(K_{11,1}+K_{11,3}+K_{11,9})u₇+(K_{11,2}+K_{11,4}+K_{11,10})v₇+K_{11,5}u₃+K_{11,6}v₃+K_{11,7}u₄+K_{11,8}v₄+K_{11,11}u₆+K_{11,12}v₆=Fₓ₆ (30)

(K_{12,1}+K_{12,3}+K_{12,9})u₇+(K_{12,2}+K_{12,4}+K_{12,10})v₇+K_{12,5}u₃+K_{12,6}v₃+K_{12,7}u₄+K_{12,8}v₄+K_{12,11}u₆+K_{12,12}v₆=F_{y6} (31)

Applying the force equilibrium equations,

Fₓ₇=Fₓ₁+Fₓ₂+Fₓ₅ (32)

F_{y7}=F_{y1}+F_{y2}+F_{y5} (33)

Results in the following joint membrane constraint equations

(20)+(22)+(28): (34)

(K₁₁+K₁₃+K₁₉+K₃₁+K₃₃+K₃₉+K₉₁+K₉₃+K₉₉)u₇+(K₁₂+K₁₄+K_{1,10}+K₃₂+K₃₄+K_{3,10}+K₉₂+K₉₄+K_{9,10})v₇+(K₁₅+K₃₅+K₉₅)u₃+(K₁₆+K₃₆+K₉₆)v₃+(K₁₇+K₃₇+K₉₇)u₄+(K₁₈+K₃₈+K₉₈)v₄+(K_{1,11}+K_{3,11}+K_{9,11})u₆+(K_{1,12}+K_{3,12}+K_{9,12})v₆=Fₓ₇ (35)

(21)+(23)+(29): (36)

(K₂₁+K₂₃+K₂₉+K₄₁+K₄₃+K₄₉+K_{10,1}+K_{10,3}+K_{10,9})u₇+(K₂₂+K₂₄+K_{2,10}+K₄₂+K₄₄+K_{4,10}+K_{10,2}+K_{10,4}+K_{10,10})v₇+(K₂₅+K₄₅+K_{10,5})u₃+(K₂₆+K₄₆+K_{10,6})v₃+(K₂₇+K₄₇+K_{10,7})u₄+(K₂₈+K₄₈+K_{10,8})v₄+(K_{2,11}+K_{4,11}+K_{10,11})u₆+(K_{2,12}+K_{4,12}+K_{10,12})v₆=F_{y7} (37)

(K_{11,1}+K_{11,3}+K_{11,9})u₇+(K_{11,2}+K_{11,4}+K_{11,10})v₇+K_{11,5}u₃+K_{11,6}v₃+K_{11,7}u₄+K_{11,8}v₄+K_{11,11}u₆+K_{11,12}v₆=Fₓ₆ (38)

(K_{12,1}+K_{12,3}+K_{12,9})u₇+(K_{12,2}+K_{12,4}+K_{12,10})v₇+K_{12,5}u₃+K_{12,6}v₃+K_{12,7}u₄+K_{12,8}v₄+K_{12,11}u₆+K_{12,12}v₆=F_{y6} (39)

(K₅₁+K₅₃+K₅₉)u₇+(K₅₂+K₅₄+K_{5,10})v₇+K₅₅u₃+K₅₆v₃+K₅₇u₄+K₅₈v₄+K_{5,11}u₆+K_{5,12}v₆=Fₓ₃ (40)

(K₆₁+K₆₃+K₆₉)u₇+(K₆₂+K₆₄+K_{6,10})v₇+K₆₅u₃+K₆₆v₃+K₆₇u₄+K₆₈v₄+K_{6,11}u₆+K_{6,12}v₆=F_{y3} (41)

(K₇₁+K₇₃+K₇₉)u₇+(K₇₂+K₇₄+K_{7,10})v₇+K₇₅u₃+K₇₆v₃+K₇₇u₄+K₇₈v₄+K_{7,11}u₆+K_{7,12}v₆=Fₓ₄ (42)

(K₈₁+K₈₃+K₈₉)u₇+(K₈₂+K₈₄+K_{8,10})v₇+K₈₅u₃+K₈₆v₃+K₈₇u₄+K₈₈v₄+K_{8,11}u₆+K_{8,12}v₆=F_{y4} (43)

Provides K^{m}:12×12→K_{reduced}^{m}:8×8.

The UEL formulation of the final membrane stiffness matrix K^{m}(8×8) without the drilling degree of freedom expressed in closed form becomes:

kₑ^{m}(i,j), where i,j=1,2, . . . 8, e.g.,

kₑ^{m}(1,1)=(K₁₁+K₁₃+K₁₉+K₃₁+K₃₃+K₃₉+K₉₁+K₉₃+K₉₉) (44)

The complete expression of this equation is shown below:

kₑ^{m}(1,1)=(K₁₁+K₁₃+K₁₉+K₃₁+K₃₃+K₃₉+K₉₁+K₉₃+K₉₉)=1.0×((E×t×((0.39×(0.47×a−0.5×b))/(0.12×a×(0.075×a−0.11×b)+(0.28×a+0.11×b)×(0.47×a−0.5×b))−(0.046×a)/(0.12×a×(0.075×a−0.11×b)+(0.28×a+0.11×b)×(0.47×a−0.5×b)−0.11×b)+(0.28×a+0.11×b)×(0.47×a−0.5×b))+(0.012×a)/(0.12×a×(0.075×a−0.11×b)+(0.28×a+0.11×b)×(0.47×a−0.5×b)))²)/(v²−1.0)−(E×t×((0.11×(0.28×a+0.11×b)(0.012×a)/(0.031×a×(0.075×a−0.11×b)+(0.075×a+0.39×b)×(0.47×a−0.5×b)))×b)×(0.47×a−0.5×b))−(0.11×(0.075×a−0.11×b))/(0.031×a×(0.075×a−0.11×b)×(0.075×a+0.39×b)×(0.47×a−0.5×b))))/(v\hat{ }2−1.0)+(1.0×E×t×((0.11×(0.47×a−0.5×b))/(0.031×a−0.11×b)+(0.075×a+0.39×b)×(0.47×a−0.5×b)) (45)

where a=joint/weld size, b=square element size, E=material Young's modulus, v=Poisson's ratio, t=thickness of sheet metal. This example equation is based on square elements around joint/spot and using software MAPLE to show its analytical form for presentation purposes. The developed UEL can be used for any shape of elements and the calculation of kₑ^{m} (i,j) is executed in UEL using numerical method.

The UEL formulation includes imposing joint bending constraints in the following equations:

$${K}^{b} d = F \qquad ( 46 )$$

$${K}^{b} [ \begin{matrix}{w}_{1} \\ {θ}_{{x}_{1}} \\ {θ}_{{y}_{1}} \\ {w}_{2} \\ {θ}_{{x}_{2}} \\ {θ}_{{y}_{2}} \\ {w}_{3} \\ {θ}_{{x}_{3}} \\ {θ}_{{y}_{3}} \\ {w}_{4} \\ {θ}_{{x}_{4}} \\ {θ}_{{y}_{4}} \\ {w}_{5} \\ {θ}_{{x}_{5}} \\ {θ}_{{y}_{5}} \\ {w}_{6} \\ {θ}_{{x}_{6}} \\ {θ}_{{y}_{6}}\end{matrix} ] = [ \begin{matrix}{F}_{z 1} \\ {M}_{{x}_{1}} \\ {M}_{{y}_{1}} \\ {F}_{z 2} \\ {M}_{{x}_{2}} \\ {M}_{{y}_{2}} \\ {F}_{z 3} \\ {M}_{{x}_{3}} \\ {M}_{{y}_{3}} \\ {F}_{z 4} \\ {M}_{{x}_{4}} \\ {M}_{{y}_{4}} \\ {F}_{z 5} \\ {M}_{{x}_{5}} \\ {M}_{{y}_{5}} \\ {F}_{z 6} \\ {M}_{{y}_{6}} \\ {M}_{{y}_{6}}\end{matrix} ] \qquad ( 47 )$$

The rigid kinematic equations/constraints include:

$${w}_{1} = {w}_{7} + a {θ}_{x 7} \qquad ( 48 )$$

$${w}_{2} = {w}_{7} + a \frac{\sqrt{2}}{2} ( {θ}_{{x}_{7}} + {θ}_{{y}_{7}} ) \qquad ( 49 )$$

$${w}_{5} = {w}_{7} + a {θ}_{{y}_{7}} \qquad ( 50 )$$

$${θ}_{{x}_{1}} = {θ}_{{x}_{2}} = {θ}_{{x}_{5}} = {θ}_{{x}_{7}} \qquad ( 51 )$$

$${θ}_{{y}_{1}} = {θ}_{{y}_{2}} = {θ}_{{y}_{5}} = {θ}_{{y}_{7}} \qquad ( 52 )$$

Where wᵢ=the displacement along the Z direction at node i.
θₓᵢ, θ_{yi}=the rotations along X and Y directions at node i.

The force/moment equilibrium equations/constraints include:

$${F}_{z 7} = {F}_{z 1} + {F}_{z 2} + {F}_{z 5} \qquad ( 53 )$$

$${M}_{x 7} = {M}_{x 1} + {M}_{x 2} + {M}_{x 5} + {aF}_{z 1} + a \frac{\sqrt{2}}{2} {F}_{z 2} \qquad ( 54 )$$

$${M}_{y 7} = {M}_{y 1} + {M}_{y 2} + {M}_{y 5} + {aF}_{z 5} + a \frac{\sqrt{2}}{2} {F}_{z 2} \qquad ( 55 )$$

Where Fzi=the force along Z direction at node i and
Mxi, Myi=: the moments along X and Y directions at node i.

Which yields K^{b}: 18×18

The joint bending constraint equations are expressed as follows:

K₁₁w₁+K₁₂θₓ_{₁}+K₁₃θ_{y}_{₁}+K₁₄w₂+K₁₅θₓ_{₂}+K₁₆θ_{y}_{₂}+K₁₇w₃+K₁₈θₓ_{₃}+K₁₉θ_{y}_{₃}+K_{1,10}w₄+K_{1,11}θₓ_{₄}+K_{1,12}θ_{y}_{₄}+K_{1,13}w₅+K_{1,14}θₓ_{₅}+K_{1,15}θ_{y}_{₅}+K_{1,16}w₆+K_{1,17}θₓ_{₆}+K_{1,18}θ_{y}_{₆}=F_{z1} (56)

K₂₁w₁+K₂₂θₓ_{₁}+K₂₃θ_{y}_{₁}+K₂₄w₂+K₂₅θₓ_{₂}+K₂₆θ_{y}_{₂}+K₂₇w₃+K₂₈θₓ_{₃}+K₂₉θ_{y}_{₃}+K_{2,10}w₄+K_{2,11}θₓ_{₄}+K_{2,12}θ_{y}_{₄}+K_{2,13}w₅+K_{2,14}θₓ_{₅}+K_{2,15}θ_{y}_{₅}+K_{2,16}w₆+K_{2,17}θₓ_{₆}+K_{2,18}θ_{y}_{₆}=Mₓ_{₁} (57)

K₃₁w₁+K₃₂θₓ_{₁}+K₃₃θ_{y}_{₁}+K₃₄w₂+K₃₅θₓ_{₂}+K₃₆θ_{y}_{₂}+K₃₇w₃+K₃₈θₓ_{₃}+K₃₉θ_{y}_{₃}+K_{3,10}w₄+K_{3,11}θₓ_{₄}+K_{3,12}θ_{y}_{₄}+K_{3,13}w₅+K_{3,14}θₓ_{₅}+K_{3,15}θ_{y}_{₅}+K_{3,16}w₆+K_{3,17}θₓ_{₆}+K_{3,18}θ_{y}_{₆}=M_{y}_{₁} (58)

K₄₁w₁+K₄₂θₓ_{₁}+K₄₃θ_{y}_{₁}+K₄₄w₂+K₄₅θₓ_{₂}+K₄₆θ_{y}_{₂}+K₄₇w₃+K₄₈θₓ_{₃}+K₄₉θ_{y}_{₃}+K_{4,10}w₄+K_{4,11}θₓ_{₄}+K_{4,12}θ_{y}_{₄}+K_{4,13}w₅+K_{4,14}θₓ_{₅}+K_{4,15}θ_{y}_{₅}+K_{4,16}w₆+K_{4,17}θₓ_{₆}+K_{4,18}θ_{y}_{₆}=F_{z2} (59)

K₅₁w₁+K₅₂θₓ_{₁}+K₅₃θ_{y}_{₁}+K₅₄w₂+K₅₅θₓ_{₂}+K₅₆θ_{y}_{₂}+K₅₇w₃+K₅₈θₓ_{₃}+K₅₉θ_{y}_{₃}+K_{5,10}w₄+K_{5,11}θₓ_{₄}+K_{5,12}θ_{y}_{₄}+K_{5,13}w₅+K_{5,14}θx₅+K_{5,15}θ_{y}_{₅}+K_{5,16}w₆+K_{5,17}θₓ_{₆}+K_{5,18}θ_{y}_{₆}=Mₓ_{₂} (60)

K₆₁w₁+K₆₂θₓ_{₁}+K₆₃θ_{y}_{₁}+K₆₄w₂+K₆₅θₓ_{₂}+K₆₆θ_{y}_{₂}+K₆₇w₃+K₆₈θₓ_{₃}+K₆₉θ_{y}_{₃}+K_{6,10}w₄+K_{6,11}θₓ_{₄}+K_{6,12}θ_{y}_{₄}+K_{6,13}w₅+K_{6,14}θₓ_{₅}+K_{6,15}θ_{y}_{₅}+K_{6,16}w₆+K_{6,17}θₓ_{₆}+K_{6,18}θ_{y}_{₆}=M_{y}_{₂} (61)

The rigid kinematic equations are:

$${w}_{1} = {w}_{7} + a {θ}_{x 7} \qquad ( 62 )$$

$${w}_{2} = {w}_{7} + a \frac{\sqrt{2}}{2} ( {θ}_{{x}_{7}} + {θ}_{{y}_{7}} ) \qquad ( 63 )$$

$${w}_{5} = {w}_{7} + a {θ}_{{x}_{7}} \qquad ( 64 )$$

$$( {K}_{11} + {K}_{14} + {K}_{1 , 13} ) {w}_{7} + ( {aK}_{11} + {K}_{12} + a \frac{\sqrt{2}}{2} {K}_{14} + {K}_{15} + {K}_{1 , 14} ) {θ}_{{x}_{7}} + ( {K}_{13} + a \frac{\sqrt{2}}{2} {K}_{14} + {K}_{16} + {aK}_{1 , 13} + {K}_{1.15} ) {θ}_{{y}_{7}} + {K}_{17} {w}_{3} + {K}_{18} {θ}_{{x}_{3}} + {K}_{19} {θ}_{{y}_{3}} + {K}_{1 , 10} {w}_{4} + {K}_{1 , 11} {θ}_{{x}_{4}} + {K}_{1 , 12} {θ}_{{y}_{4}} + {K}_{1 , 16} {w}_{6} + {K}_{1 , 17} {θ}_{{x}_{6}} + {K}_{1 , 18} {θ}_{{y}_{6}} = {F}_{z 1} \qquad ( 65 )$$

$$( {K}_{21} + {K}_{24} + {K}_{2 , 13} ) {w}_{7} + ( {aK}_{21} + {K}_{22} + a \frac{\sqrt{2}}{2} {K}_{24} + {K}_{25} + {K}_{2 , 14} ) {θ}_{{x}_{7}} + ( {K}_{23} + a \frac{\sqrt{2}}{2} {K}_{24} + {K}_{26} + {aK}_{2 , 13} + {K}_{2 , 15} ) {θ}_{{y}_{7}} + {K}_{27} {w}_{3} + {K}_{28} {θ}_{{x}_{3}} + {K}_{29} {θ}_{{y}_{3}} + {K}_{2 , 10} {w}_{4} + {K}_{2 , 11} {θ}_{{x}_{4}} + {K}_{2 , 12} {θ}_{{y}_{4}} + {K}_{2 , 16} {w}_{6} + {K}_{2 , 17} {θ}_{{x}_{6}} + {K}_{2 , 18} {θ}_{{y}_{6}} = {M}_{x 1} \qquad ( 66 )$$

$$( {K}_{31} + {K}_{34} + {K}_{3 , 13} ) {w}_{7} + ( {aK}_{31} + {K}_{32} + a \frac{\sqrt{2}}{2} {K}_{34} + {K}_{35} + {K}_{3 , 14} ) {θ}_{{x}_{7}} + ( {K}_{33} + a \frac{\sqrt{2}}{2} {K}_{34} + {K}_{36} + {aK}_{3 , 13} + {K}_{3 , 15} ) {θ}_{{y}_{7}} + {K}_{37} {w}_{3} + {K}_{38} {θ}_{{x}_{3}} + {K}_{39} {θ}_{{y}_{3}} + {K}_{3 , 10} {w}_{4} + {K}_{3 , 11} {θ}_{{x}_{4}} + {K}_{3 , 12} {θ}_{{y}_{4}} + {K}_{3 , 16} {w}_{6} + {K}_{3 , 17} {θ}_{{x}_{6}} + {K}_{3 , 18} {θ}_{{y}_{6}} = {M}_{y 1} \qquad ( 67 )$$

$$( {K}_{41} + {K}_{44} + {K}_{4 , 13} ) {w}_{7} + ( {aK}_{41} + {K}_{42} + a \frac{\sqrt{2}}{2} {K}_{44} + {K}_{45} + {K}_{4 , 14} ) {θ}_{{x}_{7}} + ( {K}_{43} + a \frac{\sqrt{2}}{2} {K}_{44} + {K}_{46} + {aK}_{4 , 13} + {K}_{4 , 15} ) {θ}_{{y}_{7}} + {K}_{47} {w}_{3} + {K}_{48} {θ}_{{x}_{3}} + {K}_{49} {θ}_{{y}_{3}} + {K}_{4 , 10} {w}_{4} + {K}_{4 , 11} {θ}_{{x}_{4}} + {K}_{4 , 12} {θ}_{{y}_{4}} + {K}_{4 , 16} {w}_{6} + {K}_{4 , 17} {θ}_{{x}_{6}} + {K}_{4 , 18} {θ}_{{y}_{6}} = {F}_{z 2} \qquad ( 68 )$$

$$( {K}_{51} + {K}_{54} + {K}_{5 , 13} ) {w}_{7} + ( {aK}_{51} + {K}_{52} + a \frac{\sqrt{2}}{2} {K}_{54} + {K}_{55} + {K}_{5 , 14} ) {θ}_{{x}_{7}} + ( {K}_{53} + a \frac{\sqrt{2}}{2} {K}_{54} + {K}_{56} + {aK}_{5 , 13} + {K}_{5 , 15} ) {θ}_{{y}_{7}} + {K}_{57} {w}_{3} + {K}_{58} {θ}_{{x}_{3}} + {K}_{59} {θ}_{{y}_{3}} + {K}_{5 , 10} {w}_{4} + {K}_{5 , 11} {θ}_{{x}_{4}} + {K}_{5 , 12} {θ}_{{y}_{4}} + {K}_{5 , 16} {w}_{6} + {K}_{5 , 17} {θ}_{{x}_{6}} + {K}_{5 , 18} {θ}_{{y}_{6}} = {M}_{x 2} \qquad ( 69 )$$

$$( {K}_{61} + {K}_{64} + {K}_{6 , 13} ) {w}_{7} + ( {aK}_{61} + {K}_{62} + a \frac{\sqrt{2}}{2} {K}_{64} + {K}_{65} + {K}_{6 , 14} ) {θ}_{{x}_{7}} + ( {K}_{63} + a \frac{\sqrt{2}}{2} {K}_{64} + {K}_{66} + {aK}_{6 , 13} + {K}_{6 , 15} ) {θ}_{{y}_{7}} + {K}_{67} {w}_{3} + {K}_{68} {θ}_{{x}_{3}} + {K}_{69} {θ}_{{y}_{3}} + {K}_{6 , 10} {w}_{4} + {K}_{6 , 11} {θ}_{{x}_{4}} + {K}_{6 , 12} {θ}_{{y}_{4}} + {K}_{6 , 16} {w}_{6} + {K}_{6 , 17} {θ}_{{x}_{6}} + {K}_{6 , 18} {θ}_{{y}_{6}} = {M}_{y 2} \qquad ( 70 )$$

$$( {K}_{71} + {K}_{74} + {K}_{7 , 13} ) {w}_{7} + ( {aK}_{71} + {K}_{72} + a \frac{\sqrt{2}}{2} {K}_{74} + {K}_{75} + {K}_{7 , 14} ) {θ}_{{x}_{7}} + ( {K}_{73} + a \frac{\sqrt{2}}{2} {K}_{74} + {K}_{76} + {aK}_{7 , 13} + {K}_{7 , 15} ) {θ}_{{y}_{7}} + {K}_{77} {w}_{3} + {K}_{78} {θ}_{{x}_{3}} + {K}_{79} {θ}_{{y}_{3}} + {K}_{7 , 10} {w}_{4} + {K}_{7 , 11} {θ}_{{x}_{4}} + {K}_{7 , 12} {θ}_{{y}_{4}} + {K}_{7 , 16} {w}_{6} + {K}_{7 , 17} {θ}_{{x}_{6}} + {K}_{7 , 18} {θ}_{{y}_{6}} = {F}_{z 3} \qquad ( 71 )$$

$$( {K}_{81} + {K}_{84} + {K}_{8 , 13} ) {w}_{7} + ( {aK}_{81} + {K}_{82} + a \frac{\sqrt{2}}{2} {K}_{84} + {K}_{85} + {K}_{8 , 14} ) {θ}_{{x}_{7}} + ( {K}_{83} + a \frac{\sqrt{2}}{2} {K}_{84} + {K}_{86} + {aK}_{8 , 13} + {K}_{8 , 15} ) {θ}_{{y}_{7}} + {K}_{87} {w}_{3} + {K}_{88} {θ}_{{x}_{3}} + {K}_{89} {θ}_{{y}_{3}} + {K}_{8 , 10} {w}_{4} + {K}_{8 , 11} {θ}_{{x}_{4}} + {K}_{8 , 12} {θ}_{{y}_{4}} + {K}_{8 , 16} {w}_{6} + {K}_{8 , 17} {θ}_{{x}_{6}} + {K}_{8 , 18} {θ}_{{y}_{6}} = {M}_{x 3} \qquad ( 72 )$$

$$( {K}_{91} + {K}_{94} + {K}_{9 , 13} ) {w}_{7} + ( {aK}_{91} + {K}_{92} + a \frac{\sqrt{2}}{2} {K}_{94} + {K}_{95} + {K}_{9 , 14} ) {θ}_{{x}_{7}} + ( {K}_{93} + a \frac{\sqrt{2}}{2} {K}_{94} + {K}_{96} + {aK}_{9 , 13} + {K}_{9 , 15} ) {θ}_{{y}_{7}} + {K}_{97} {w}_{3} + {K}_{98} {θ}_{{x}_{3}} + {K}_{99} {θ}_{{y}_{3}} + {K}_{9 , 10} {w}_{4} + {K}_{9 , 11} {θ}_{{x}_{4}} + {K}_{9 , 12} {θ}_{{y}_{4}} + {K}_{9 , 16} {w}_{6} + {K}_{9 , 17} {θ}_{{x}_{6}} + {K}_{9 , 18} {θ}_{{y}_{6}} = {M}_{y 3} \qquad ( 73 )$$

$$( {K}_{10 , 1} + {K}_{10 , 4} + {K}_{10 , 13} ) {w}_{7} + ( {aK}_{10 , 1} + {K}_{10 , 2} + a \frac{\sqrt{2}}{2} {K}_{10 , 4} + {K}_{10 , 5} + {K}_{10 , 14} ) {θ}_{{x}_{7}} + ( {K}_{10 , 3} + a \frac{\sqrt{2}}{2} {K}_{10 , 4} + {K}_{10 , 6} + {aK}_{10 , 13} + {K}_{10 , 15} ) {θ}_{{y}_{7}} + {K}_{10 , 7} {w}_{3} + {K}_{10 , 8} {θ}_{{x}_{3}} + {K}_{10 , 9} {θ}_{{y}_{3}} + {K}_{10 , 10} {w}_{4} + {K}_{10 , 11} {θ}_{{x}_{4}} + {K}_{10 , 12} {θ}_{{y}_{4}} + {K}_{10 , 16} {w}_{6} + {K}_{10 , 17} {θ}_{{x}_{6}} + {K}_{10 , 18} {θ}_{{y}_{6}} = {F}_{z 4} \qquad ( 74 )$$

$$( {K}_{11 , 1} + {K}_{11 , 4} + {K}_{11 , 13} ) {w}_{7} + ( {aK}_{11 , 1} + {K}_{11 , 2} + a \frac{\sqrt{2}}{2} {K}_{11 , 4} + {K}_{11 , 5} + {K}_{11 , 14} ) {θ}_{{x}_{7}} + ( {K}_{11 , 3} + a \frac{\sqrt{2}}{2} {K}_{11 , 4} + {K}_{11 , 6} + {aK}_{11 , 13} + {K}_{11 , 15} ) {θ}_{{y}_{7}} + {K}_{11 , 7} {w}_{3} + {K}_{11 , 8} {θ}_{{x}_{3}} + {K}_{11 , 9} {θ}_{{y}_{3}} + {K}_{11 , 10} {w}_{4} + {K}_{11 , 11} {θ}_{{x}_{4}} + {K}_{11 , 12} {θ}_{{y}_{4}} + {K}_{11 , 16} {w}_{6} + {K}_{11 , 17} {θ}_{{x}_{6}} + {K}_{11 , 18} {θ}_{{y}_{6}} = {M}_{x 4} \qquad ( 75 )$$

$$( {K}_{12 , 1} + {K}_{12 , 4} + {K}_{12 , 13} ) {w}_{7} + ( {aK}_{12 , 1} + {K}_{12 , 2} + a \frac{\sqrt{2}}{2} {K}_{12 , 4} + {K}_{12 , 5} + {K}_{12 , 14} ) {θ}_{{x}_{7}} + ( {K}_{12 , 3} + a \frac{\sqrt{2}}{2} {K}_{12 , 4} + {K}_{12 , 6} + {aK}_{12 , 13} + {K}_{12 , 15} ) {θ}_{{y}_{7}} + {K}_{12 , 7} {w}_{3} + {K}_{12 , 8} {θ}_{{x}_{3}} + {K}_{12 , 9} {θ}_{{y}_{3}} + {K}_{12 , 10} {w}_{4} + {K}_{12 , 11} {θ}_{{x}_{4}} + {K}_{12 , 12} {θ}_{{y}_{4}} + {K}_{12 , 16} {w}_{6} + {K}_{12 , 17} {θ}_{{x}_{6}} + {K}_{12 , 18} {θ}_{{y}_{6}} = {M}_{y 4} \qquad ( 76 )$$

$$( {K}_{13 , 1} + {K}_{13 , 4} + {K}_{13 , 13} ) {w}_{7} + ( {aK}_{13 , 1} + {K}_{13 , 2} + a \frac{\sqrt{2}}{2} {K}_{13 , 4} + {K}_{13 , 5} + {K}_{13 , 14} ) {θ}_{{x}_{7}} + ( {K}_{13 , 3} + a \frac{\sqrt{2}}{2} {K}_{13 , 4} + {K}_{13 , 6} + {aK}_{13 , 13} + {K}_{13 , 15} ) {θ}_{{y}_{7}} + {K}_{13 , 7} {w}_{3} + {K}_{13 , 8} {θ}_{{x}_{3}} + {K}_{13 , 9} {θ}_{{y}_{3}} + {K}_{13 , 10} {w}_{4} + {K}_{13 , 11} {θ}_{{x}_{4}} + {K}_{13 , 12} {θ}_{{y}_{4}} + {K}_{13 , 16} {w}_{6} + {K}_{13 , 17} {θ}_{{x}_{6}} + {K}_{13 , 18} {θ}_{{y}_{6}} = {F}_{z 5} \qquad ( 77 )$$

$$( {K}_{14 , 1} + {K}_{14 , 4} + {K}_{14 , 13} ) {w}_{7} + ( {aK}_{14 , 1} + {K}_{14 , 2} + a \frac{\sqrt{2}}{2} {K}_{14 , 4} + {K}_{14 , 5} + {K}_{14 , 14} ) {θ}_{{x}_{7}} + ( {K}_{14 , 3} + a \frac{\sqrt{2}}{2} {K}_{14 , 4} + {K}_{14 , 6} + {aK}_{14 , 13} + {K}_{14 , 15} ) {θ}_{{y}_{7}} + {K}_{14 , 7} {w}_{3} + {K}_{14 , 8} {θ}_{{x}_{3}} + {K}_{14 , 9} {θ}_{{y}_{3}} + {K}_{14 , 10} {w}_{4} + {K}_{14 , 11} {θ}_{{x}_{4}} + {K}_{14 , 12} {θ}_{{y}_{4}} + {K}_{14 , 16} {w}_{6} + {K}_{14 , 17} {θ}_{{x}_{6}} + {K}_{14 , 18} {θ}_{{y}_{6}} = {M}_{x 5} \qquad ( 78 )$$

$$( {K}_{15 , 1} + {K}_{15 , 4} + {K}_{15 , 13} ) {w}_{7} + ( {aK}_{15 , 1} + {K}_{15 , 2} + a \frac{\sqrt{2}}{2} {K}_{15 , 4} + {K}_{15 , 5} + {K}_{15 , 14} ) {θ}_{{x}_{7}} + ( {K}_{15 , 3} + a \frac{\sqrt{2}}{2} {K}_{15 , 4} + {K}_{15 , 6} + {aK}_{15 , 13} + {K}_{15 , 15} ) {θ}_{{y}_{7}} + {K}_{15 , 7} {w}_{3} + {K}_{15 , 8} {θ}_{{x}_{3}} + {K}_{15 , 9} {θ}_{{y}_{3}} + {K}_{15 , 10} {w}_{4} + {K}_{15 , 11} {θ}_{{x}_{4}} + {K}_{15 , 12} {θ}_{{y}_{4}} + {K}_{15 , 16} {w}_{6} + {K}_{15 , 17} {θ}_{{x}_{6}} + {K}_{15 , 18} {θ}_{{y}_{6}} = {M}_{y 5} \qquad ( 79 )$$

$$( {K}_{16 , 1} + {K}_{16 , 4} + {K}_{16 , 13} ) {w}_{7} + ( {aK}_{16 , 1} + {K}_{16 , 2} + a \frac{\sqrt{2}}{2} {K}_{16 , 4} + {K}_{16 , 5} + {K}_{16 , 14} ) {θ}_{{x}_{7}} + ( {K}_{16 , 3} + a \frac{\sqrt{2}}{2} {K}_{16 , 4} + {K}_{16 , 6} + {aK}_{16 , 13} + {K}_{16 , 15} ) {θ}_{{y}_{7}} + {K}_{16 , 7} {w}_{3} + {K}_{16 , 8} {θ}_{{x}_{3}} + {K}_{16 , 9} {θ}_{{y}_{3}} + {K}_{16 , 10} {w}_{4} + {K}_{16 , 11} {θ}_{{x}_{4}} + {K}_{16 , 12} {θ}_{{y}_{4}} + {K}_{16 , 16} {w}_{6} + {K}_{16 , 17} {θ}_{{x}_{6}} + {K}_{16 , 18} {θ}_{{y}_{6}} = {F}_{z 6} \qquad ( 80 )$$

$$( {K}_{17 , 1} + {K}_{17 , 4} + {K}_{17 , 13} ) {w}_{7} + ( {aK}_{17 , 1} + {K}_{17 , 2} + a \frac{\sqrt{2}}{2} {K}_{17 , 4} + {K}_{17 , 5} + {K}_{17 , 14} ) {θ}_{{x}_{7}} + ( {K}_{17 , 3} + a \frac{\sqrt{2}}{2} {K}_{17 , 4} + {K}_{17 , 6} + {aK}_{17 , 13} + {K}_{17 , 15} ) {θ}_{{y}_{7}} + {K}_{17 , 7} {w}_{3} + {K}_{17 , 8} {θ}_{{x}_{3}} + {K}_{17 , 9} {θ}_{{y}_{3}} + {K}_{17 , 10} {w}_{4} + {K}_{17 , 11} {θ}_{{x}_{4}} + {K}_{17 , 12} {θ}_{{y}_{4}} + {K}_{17 , 16} {w}_{6} + {K}_{17 , 17} {θ}_{{x}_{6}} + {K}_{17 , 18} {θ}_{{y}_{6}} = {M}_{x 6} \qquad ( 81 )$$

$$( {K}_{18 , 1} + {K}_{18 , 4} + {K}_{18 , 13} ) {w}_{7} + ( {aK}_{18 , 1} + {K}_{18 , 2} + a \frac{\sqrt{2}}{2} {K}_{18 , 4} + {K}_{18 , 5} + {K}_{18 , 14} ) {θ}_{{x}_{7}} + ( {K}_{18 , 3} + a \frac{\sqrt{2}}{2} {K}_{18 , 4} + {K}_{18 , 6} + {aK}_{18 , 13} + {K}_{18 , 15} ) {θ}_{{y}_{7}} + {K}_{18 , 7} {w}_{3} + {K}_{18 , 8} {θ}_{{x}_{3}} + {K}_{18 , 9} {θ}_{{y}_{3}} + {K}_{18 , 10} {w}_{4} + {K}_{18 , 11} {θ}_{{x}_{4}} + {K}_{18 , 12} {θ}_{{y}_{4}} + {K}_{18 , 16} {w}_{6} + {K}_{18 , 17} {θ}_{{x}_{6}} + {K}_{18 , 18} {θ}_{{y}_{6}} = {M}_{y 6} \qquad ( 82 )$$

With Force/moment equilibrium equations:

$${F}_{z 7} = {F}_{z 1} + {F}_{z 2} + {F}_{z 5} \qquad ( 83 )$$

$${M}_{x 7} = {M}_{x 1} + {M}_{x 2} + {M}_{x 5} + {aF}_{z 1} + a \frac{\sqrt{2}}{2} {F}_{z 2} \qquad ( 84 )$$

$${M}_{y 7} = {M}_{y 1} + {M}_{y 2} + {M}_{y 5} + {aF}_{z 5} + a \frac{\sqrt{2}}{2} {F}_{z 2} \qquad ( 85 )$$

$$( {K}_{11} + {K}_{14} + {K}_{1 , 13} + {K}_{41} + {K}_{44} + {K}_{4 , 13} + {K}_{13 , 1} + {K}_{13 , 4} + {K}_{13 , 13} ) {w}_{7} + ( {aK}_{11} + {K}_{12} + a \frac{\sqrt{2}}{2} {K}_{14} + {K}_{15} + {K}_{1 , 14} + {aK}_{41} + {K}_{42} + a \frac{\sqrt{2}}{2} {K}_{44} + {K}_{45} + {K}_{4 , 14} + {aK}_{13 , 1} + {K}_{13 , 2} + a \frac{\sqrt{2}}{2} {K}_{13 , 4} + {K}_{13 , 5} + {K}_{13 , 14} ) {θ}_{{x}_{7}} + ( {K}_{13} + a \frac{\sqrt{2}}{2} {K}_{14} + {K}_{16} + {aK}_{1 , 13} + {K}_{1 , 15} + {K}_{43} + a \frac{\sqrt{2}}{2} {K}_{44} + {K}_{46} + {aK}_{4 , 13} + {K}_{4 , 15} + {K}_{13 , 3} + a \frac{\sqrt{2}}{2} {K}_{13 , 4} + {K}_{13 , 6} + {aK}_{13 , 13} + {K}_{13 , 15} ) {θ}_{{y}_{7}} + ( {K}_{17} + {K}_{47} + {K}_{13 , 7} ) {w}_{3} + ( {K}_{18} + {K}_{48} + {K}_{13 , 8} ) {θ}_{{x}_{3}} + ( {K}_{19} + {K}_{49} + {K}_{13 , 9} ) {θ}_{{y}_{3}} + ( {K}_{1 , 10} + {K}_{4 , 10} + {K}_{13 , 10} ) {w}_{4} + ( {K}_{1 , 11} + {K}_{4 , 11} + {K}_{13 , 11} ) {θ}_{{x}_{4}} + ( {K}_{1 , 12} + {K}_{4 , 12} + {K}_{13 , 12} ) {θ}_{{y}_{4}} + ( {K}_{1 , 16} + {K}_{4 , 16} + {K}_{13 , 16} ) {w}_{6} + ( {K}_{1 , 17} + {K}_{4 , 17} + {K}_{13 , 17} ) {θ}_{{x}_{6}} + ( {K}_{1 , 18} + {K}_{4 , 18} + {K}_{13 , 18} ) {θ}_{{y}_{6}} = {F}_{z 7} \qquad ( 86 )$$

$$( {K}_{21} + {K}_{24} + {K}_{2 , 13} + {K}_{51} + {K}_{54} + {K}_{5 , 13} + {K}_{14 , 1} + {K}_{14 , 4} + {K}_{14 , 13} + a ( {K}_{11} + {K}_{14} + {K}_{1 , 13} ) + a \frac{\sqrt{2}}{2} ( {K}_{41} + {K}_{44} + {K}_{4 , 33} ) ) {w}_{7} + ( {aK}_{21} + {K}_{22} + a \frac{\sqrt{2}}{2} {K}_{24} + {K}_{25} + {K}_{2 , 14} + {aK}_{21} + {K}_{22} + a \frac{\sqrt{2}}{2} {K}_{24} + {K}_{25} + {K}_{2 , 14} + {aK}_{14 , 1} + {K}_{14 , 2} + a \frac{\sqrt{2}}{2} {K}_{14 , 4} + {K}_{14 , 5} + {K}_{14 , 14} + a ( {aK}_{11} + {K}_{12} + a \frac{\sqrt{2}}{2} {K}_{14} + {K}_{15} + {K}_{1 , 14} ) + a \frac{\sqrt{2}}{2} ( {aK}_{41} + {K}_{42} + a \frac{\sqrt{2}}{2} {K}_{44} + {K}_{45} + {K}_{4 , 14} ) ) {θ}_{{x}_{7}} + ( {K}_{23} + a \frac{\sqrt{2}}{2} {K}_{24} + {K}_{26} + {aK}_{2 , 13} + {K}_{2 , 15} + {K}_{53} + a \frac{\sqrt{2}}{2} {K}_{54} + {K}_{56} + {aK}_{5 , 13} + {K}_{5 , 15} + {K}_{14 , 3} + a \frac{\sqrt{2}}{2} {K}_{14 , 4} + {K}_{14 , 6} + {aK}_{14 , 13} + {K}_{14 , 15} + a ( {K}_{13} + a \frac{\sqrt{2}}{2} {K}_{14} + {K}_{16} + {aK}_{1 , 13} + {K}_{1 , 15} ) + a \frac{\sqrt{2}}{2} ( {K}_{43} + a \frac{\sqrt{2}}{2} {K}_{44} + {K}_{46} + {aK}_{4 , 13} + {K}_{4 , 15} ) ) {θ}_{{y}_{7}} + ( {K}_{27} + {K}_{57} + {K}_{14 , 7} + {aK}_{17} + a \frac{\sqrt{2}}{2} {K}_{47} ) {w}_{3} + ( {K}_{28} + {K}_{58} + {K}_{14 , 8} + {aK}_{18} + a \frac{\sqrt{2}}{2} {K}_{48} ) {θ}_{{x}_{3}} + ( {K}_{29} + {K}_{59} + {K}_{14 , 9} + {aK}_{19} + a \frac{\sqrt{2}}{2} {K}_{49} ) {θ}_{{y}_{3}} + ( {K}_{2 , 10} + {K}_{5 , 10} + {K}_{14 , 10} + {aK}_{1 , 10} + a \frac{\sqrt{2}}{2} {K}_{4 , 10} ) {w}_{4} + ( {K}_{2 , 11} + {K}_{5 , 11} + {K}_{14 , 11} + {aK}_{1 , 11} + a \frac{\sqrt{2}}{2} {K}_{4 , 11} ) {θ}_{{x}_{4}} + ( {K}_{2 , 12} + {K}_{5 , 12} + {K}_{14 , 12} + {aK}_{1 , 12} + a \frac{\sqrt{2}}{2} {K}_{4 , 12} ) {θ}_{{y}_{4}} + ( {K}_{2 , 16} + {K}_{5 , 16} + {K}_{14 , 16} + {aK}_{1 , 16} + a \frac{\sqrt{2}}{2} {K}_{4 , 16} ) {w}_{6} + ( {K}_{2 , 17} + {K}_{5 , 17} + {K}_{14 , 17} + {aK}_{1 , 17} + a \frac{\sqrt{2}}{2} {K}_{4 , 17} ) {θ}_{{x}_{6}} + ( {K}_{2 , 18} + {K}_{5 , 18} + {K}_{14 , 18} + {aK}_{1 , 18} + a \frac{\sqrt{2}}{2} {K}_{4 , 18} ) {θ}_{{y}_{6}} = {M}_{x 7} \qquad ( 87 )$$

$$( {K}_{31} + {K}_{34} + {K}_{3 , 13} + {K}_{61} + {K}_{64} + {K}_{6 , 13} + {K}_{15 , 1} + {K}_{15 , 4} + {K}_{15 , 13} + a ( {K}_{13 , 1} + {K}_{13 , 4} + {K}_{13 , 13} ) + a \frac{\sqrt{2}}{2} ( {K}_{41} + {K}_{44} + {K}_{4 , 13} ) ) {w}_{7} + ( {aK}_{31} + {K}_{32} + a \frac{\sqrt{2}}{2} {K}_{34} + {K}_{35} + {K}_{3 , 14} + {aK}_{61} + {K}_{62} + a \frac{\sqrt{2}}{2} {K}_{64} + {K}_{6 , 14} + {aK}_{15 , 1} + {K}_{15 , 2} + a \frac{\sqrt{2}}{2} {K}_{15 , 4} + {K}_{15 , 5} + {K}_{15 , 14} + a ( {K}_{13 , 1} + {K}_{13 , 2} + a \frac{\sqrt{2}}{2} {K}_{13 , 4} + {K}_{13 , 5} + {K}_{13 , 14} ) + a \frac{\sqrt{2}}{2} {K}_{15 , 4} + {K}_{15 , 5} + {K}_{15 , 14} + a ( {aK}_{13 , 1} + {K}_{13 , 2} + a \frac{\sqrt{2}}{2} {K}_{13 , 4} + {K}_{13 , 5} + {K}_{13 , 14} ) + a \frac{\sqrt{2}}{2} ( {aK}_{41} + {K}_{42} + a \frac{\sqrt{2}}{2} {K}_{44} + {K}_{45} + {K}_{4 , 14} ) ) {θ}_{{x}_{7}} + ( {K}_{33} + a \frac{\sqrt{2}}{2} {K}_{34} + {K}_{36} + {aK}_{3 , 13} + {K}_{3 , 15} + {K}_{63} + a \frac{\sqrt{2}}{2} {K}_{64} + {K}_{66} + {aK}_{6 , 13} + {K}_{6 , 15} + {K}_{15 , 3} + a \frac{\sqrt{2}}{2} {K}_{15 , 4} + {K}_{15 , 6} + {aK}_{15 , 13} + {K}_{15 , 15} + a ( {K}_{13 , 3} + a \frac{\sqrt{2}}{2} {K}_{13 , 4} + {K}_{13 , 6} + {aK}_{13 , 13} + {K}_{13 , 15} ) + a \frac{\sqrt{2}}{2} ( {K}_{43} + a \frac{\sqrt{2}}{2} {K}_{44} + {K}_{46} + {aK}_{4 , 13} + {K}_{4 , 13} ) ) {θ}_{{y}_{7}} + ( {K}_{37} + {K}_{67} + {K}_{15 , 7} + {aK}_{13 , 7} + a \frac{\sqrt{2}}{2} {K}_{47} ) {w}_{3} + ( {K}_{38} + {K}_{68} + {K}_{15 , 8} + {aK}_{13 , 8} + a \frac{\sqrt{2}}{2} {K}_{48} ) {θ}_{{x}_{3}} + ( {K}_{39} + {K}_{69} + {K}_{15 , 9} + {aK}_{13 , 9} + a \frac{\sqrt{2}}{2} {K}_{49} ) {θ}_{{y}_{3}} + ( {K}_{3 , 10} + {K}_{6 , 10} + {K}_{15 , 10} + {aK}_{13 , 10} + a \frac{\sqrt{2}}{2} {K}_{4 , 10} ) {w}_{4} + ( {K}_{3 , 11} + {K}_{6 , 11} + {K}_{15 , 11} + {aK}_{13 , 11} + a \frac{\sqrt{2}}{2} {K}_{4 , 11} ) {θ}_{{x}_{4}} + ( {K}_{3 , 12} + {K}_{6 , 12} + {K}_{15 , 12} + {aK}_{13 , 12} + a \frac{\sqrt{2}}{2} {K}_{4 , 12} ) {θ}_{{y}_{4}} + ( {K}_{3 , 16} + {K}_{6 , 16} + {K}_{15 , 16} + {aK}_{13 , 16} + a \frac{\sqrt{2}}{2} {K}_{4 , 16} ) {w}_{6} + ( {K}_{3 , 17} + {K}_{6 , 17} + {K}_{15 , 17} + {aK}_{13 , 17} + a \frac{\sqrt{2}}{2} {K}_{4 , 17} ) {θ}_{{x}_{6}} + ( {K}_{3 , 18} + {K}_{6 , 18} + {K}_{15 , 18} + {aK}_{13 , 18} + a \frac{\sqrt{2}}{2} {K}_{4 , 18} ) {θ}_{{y}_{6}} = {M}_{y 7} \qquad ( 88 )$$

$$( {K}_{71} + {K}_{74} + {K}_{7 , 13} ) {w}_{7} + ( {aK}_{71} + {K}_{72} + a \frac{\sqrt{2}}{2} {K}_{74} + {K}_{75} + {K}_{7 , 14} ) {θ}_{{x}_{7}} + ( {K}_{73} + a \frac{\sqrt{2}}{2} {K}_{74} + {K}_{76} + {aK}_{7 , 13} + {K}_{7 , 15} ) {θ}_{{y}_{7}} + {K}_{77} {w}_{3} + {K}_{78} {θ}_{{x}_{3}} + {K}_{79} {θ}_{{y}_{3}} + {K}_{7 , 10} {w}_{4} + {K}_{7 , 11} {θ}_{{x}_{4}} + {K}_{7 , 12} {θ}_{{y}_{4}} + {K}_{7 , 16} {w}_{6} + {K}_{7 , 17} {θ}_{{x}_{6}} + {K}_{7 , 18} {θ}_{{y}_{6}} = {F}_{z 3} \qquad ( 89 )$$

$$( {K}_{81} + {K}_{84} + {K}_{8 , 13} ) {w}_{7} + ( {aK}_{81} + {K}_{82} + a \frac{\sqrt{2}}{2} {K}_{84} + {K}_{85} + {K}_{8 , 14} ) {θ}_{{x}_{7}} + ( {K}_{83} + a \frac{\sqrt{2}}{2} {K}_{84} + {K}_{86} + {aK}_{8 , 13} + {K}_{8 , 15} ) {θ}_{{y}_{7}} + {K}_{87} {w}_{3} + {K}_{88} {θ}_{{x}_{3}} + {K}_{89} {θ}_{{y}_{3}} + {K}_{8 , 10} {w}_{4} + {K}_{8 , 11} {θ}_{{x}_{4}} + {K}_{8 , 12} {θ}_{{y}_{4}} + {K}_{8 , 16} {w}_{6} + {K}_{8 , 17} {θ}_{{x}_{6}} + {K}_{8 , 18} {θ}_{{y}_{6}} = {M}_{x 3} \qquad ( 90 )$$

$$( {K}_{91} + {K}_{94} + {K}_{9 , 13} ) {w}_{7} + ( {aK}_{91} + {K}_{92} + a \frac{\sqrt{2}}{2} {K}_{94} + {K}_{95} + {K}_{9 , 14} ) {θ}_{{x}_{7}} + ( {K}_{93} + a \frac{\sqrt{2}}{2} {K}_{94} + {K}_{96} + {aK}_{9 , 13} + {K}_{9 , 15} ) {θ}_{{y}_{7}} + {K}_{97} {w}_{3} + {K}_{98} {θ}_{{x}_{3}} + {K}_{99} {θ}_{{y}_{3}} + {K}_{9 , 10} {w}_{4} + {K}_{9 , 11} {θ}_{{x}_{4}} + {K}_{9 , 12} {θ}_{{y}_{4}} + {K}_{9 , 16} {w}_{6} + {K}_{9 , 17} {θ}_{{x}_{6}} + {K}_{9 , 18} {θ}_{{y}_{6}} = {M}_{y 3} \qquad ( 91 )$$

$$( {K}_{10 , 1} + {K}_{10 , 4} + {K}_{10 , 13} ) {w}_{7} + ( {aK}_{10 , 1} + {K}_{10 , 2} + a \frac{\sqrt{2}}{2} {K}_{10 , 4} + {K}_{10 , 5} + {K}_{10 , 14} ) {θ}_{{x}_{7}} + ( {K}_{10 , 3} + a \frac{\sqrt{2}}{2} {K}_{10 , 4} + {K}_{10 , 6} + {aK}_{10 , 13} + {K}_{10 , 15} ) {θ}_{{y}_{7}} + {K}_{10 , 7} {w}_{3} + {K}_{10 , 8} {θ}_{{x}_{3}} + {K}_{10 , 9} {θ}_{{y}_{3}} + {K}_{10 , 10} {w}_{4} + {K}_{10 , 11} {θ}_{{x}_{4}} + {K}_{10 , 12} {θ}_{{y}_{4}} + {K}_{10 , 16} {w}_{6} + {K}_{10 , 17} {θ}_{{x}_{6}} + {K}_{10 , 18} {θ}_{{y}_{6}} = {F}_{z 4} \qquad ( 92 )$$

$$( {K}_{11 , 1} + {K}_{11 , 4} + {K}_{11 , 13} ) {w}_{7} + ( {aK}_{11 , 1} + {K}_{11 , 2} + a \frac{\sqrt{2}}{2} {K}_{11 , 4} + {K}_{11 , 5} + {K}_{11 , 14} ) {θ}_{{x}_{7}} + ( {K}_{11 , 3} + a \frac{\sqrt{2}}{2} {K}_{11 , 4} + {K}_{11 , 6} + {aK}_{11 , 13} + {K}_{11 , 15} ) {θ}_{{y}_{7}} + {K}_{11 , 7} {w}_{3} + {K}_{11 , 8} {θ}_{{x}_{3}} + {K}_{11 , 9} {θ}_{{y}_{3}} + {K}_{11 , 10} {w}_{4} + {K}_{11 , 10} {w}_{4} + {K}_{11 , 11} {θ}_{{x}_{4}} + {K}_{11 , 12} {θ}_{{y}_{4}} + {K}_{11 , 16} {w}_{6} + {K}_{11 , 17} {θ}_{{x}_{6}} + {K}_{11 , 18} {θ}_{{y}_{6}} = {M}_{x 4} \qquad ( 93 )$$

$$( {K}_{12 , 1} + {K}_{12 , 4} + {K}_{12 , 13} ) {w}_{7} + ( {aK}_{12 , 1} + {K}_{12 , 2} + a \frac{\sqrt{2}}{2} {K}_{12 , 4} + {K}_{12 , 5} + {K}_{12 , 14} ) {θ}_{{x}_{7}} + ( {K}_{12 , 3} + a \frac{\sqrt{2}}{2} {K}_{12 , 4} + {K}_{12 , 6} + {aK}_{12 , 13} + {K}_{12 , 15} ) {θ}_{{y}_{7}} + {K}_{12 , 7} {w}_{3} + {K}_{12 , 8} {θ}_{{x}_{3}} + {K}_{12 , 9} {θ}_{{y}_{3}} + {K}_{12 , 10} {w}_{4} + {K}_{12 , 11} {θ}_{{x}_{4}} + {K}_{12 , 12} {θ}_{{y}_{4}} + {K}_{12 , 16} {w}_{6} + {K}_{12 , 17} {θ}_{{x}_{6}} + {K}_{12 , 18} {θ}_{{y}_{6}} = {M}_{y 4} \qquad ( 94 )$$

$$( {K}_{16 , 1} + {K}_{16 , 4} + {K}_{16 , 13} ) {w}_{7} + ( {aK}_{16 , 1} + {K}_{16 , 2} + a \frac{\sqrt{2}}{2} {K}_{16 , 4} + {K}_{16 , 5} + {K}_{16 , 14} ) {θ}_{{x}_{7}} + ( {K}_{16 , 3} + a \frac{\sqrt{2}}{2} {K}_{16 , 4} + {K}_{16 , 6} + {aK}_{16 , 13} + {K}_{16 , 15} ) {θ}_{{y}_{7}} + {K}_{16 , 7} {w}_{3} + {K}_{16 , 8} {θ}_{{x}_{3}} + {K}_{16 , 9} {θ}_{{y}_{3}} + {K}_{16 , 9} {θ}_{{y}_{3}} + {K}_{16 , 10} {w}_{4} + {K}_{16 , 11} {θ}_{{x}_{4}} + {K}_{16 , 12} {θ}_{{y}_{4}} + {K}_{16 , 16} {w}_{6} + {K}_{16 , 17} {θ}_{{x}_{6}} + {K}_{16 , 18} {θ}_{{y}_{6}} = {F}_{z 6} \qquad ( 95 )$$

$$( {K}_{17 , 1} + {K}_{17 , 4} + {K}_{17 , 13} ) {w}_{7} + ( {aK}_{17 , 1} + {K}_{17 , 2} + a \frac{\sqrt{2}}{2} {K}_{17 , 4} + {K}_{17 , 5} + {K}_{17 , 14} ) {θ}_{{x}_{7}} + ( {K}_{17 , 3} + a \frac{\sqrt{2}}{2} {K}_{17 , 4} + {K}_{17 , 6} + {aK}_{17 , 13} + {K}_{17 , 15} ) {θ}_{{y}_{7}} + {K}_{17 , 7} {w}_{3} + {K}_{17 , 8} {θ}_{{x}_{3}} + {K}_{17 , 9} {θ}_{{y}_{3}} + {K}_{17 , 10} {w}_{4} + {K}_{17 , 11} {θ}_{{x}_{4}} + {K}_{17 , 12} {θ}_{{y}_{4}} + {K}_{17 , 16} {w}_{6} + {K}_{17 , 17} {θ}_{{x}_{6}} + {K}_{17 , 18} {θ}_{{y}_{6}} = {M}_{x 6} \qquad ( 96 )$$

$$( {K}_{18 , 1} + {K}_{18 , 4} + {K}_{18 , 13} ) {w}_{7} + ( {aK}_{18 , 1} + {K}_{18 , 2} + a \frac{\sqrt{2}}{2} {K}_{18 , 4} + {K}_{18 , 5} + {K}_{18 , 14} ) {θ}_{{x}_{7}} + ( {K}_{18 , 3} + a \frac{\sqrt{2}}{2} {K}_{18 , 4} + {K}_{18 , 6} + {aK}_{18 , 13} + {K}_{18 , 15} ) {θ}_{{y}_{7}} + {K}_{18 , 7} {w}_{3} + {K}_{18 , 8} {θ}_{{x}_{3}} + {K}_{18 , 9} {θ}_{{y}_{3}} + {K}_{18 , 10} {w}_{4} + {K}_{18 , 11} {θ}_{{x}_{4}} + {K}_{18 , 12} {θ}_{{y}_{4}} + {K}_{18 , 16} {w}_{6} + {K}_{18 , 17} {θ}_{{x}_{6}} + {K}_{18 , 18} {θ}_{{y}_{4}} = {M}_{y 6} \qquad ( 97 )$$

### Reduced K^{b} to 12×12.

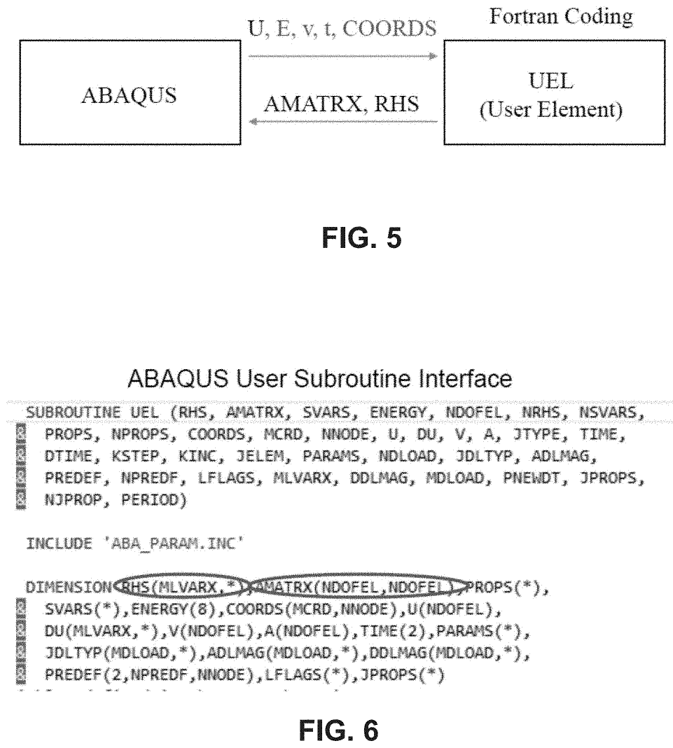

The final outcome of the UEL method can be directly used through a user-interface available in major commercial Finite Element software vendors (e.g., ABAQUS™). As an example for purposes of demonstration, the implementation of the UEL technique in ABAQUS™ as a User Element Subroutine (UEL) in FIGS. 5 and 6 where,
U=displacement,
AMATRX=UEL stiffness matrix, and
RHS=force/moment vector.

As such, any users of commercial FE software packages, once gaining access of the UEL subroutine, can treat the UEL just like a regular element in their element libraries for performing their own computer aided engineering (CAE) structural analyses. The UEL model calculations and the use of the UEL data in a commercial finite element software package. In particular, fill out all 24×24 entries of UEL stiffness matrix K into the array “AMTRX” on the left, e.g., k(1,1) above. The validated UEL Fortran code is interfaced with ABAQUS™ for numerous spot welded components.

The stresses around joints, essential for structural durability or fatigue evaluation, can then be computed by invoking two well-documented methods by using the nodal forces and nodal moments available at the virtual nodes internal to the UEL elements. The two methods for computing the structural stresses at joints with demonstrated mesh-size insensitivity include:
Method 1: Decompose nodal forces/moments into a series of simple loading modes on which analytical solutions are available and then superimpose them into the total structural stress solution (see Zhang, Lunyu, Pingsha Dong, Yuedong Wang, and Jifa Mei. “A Coarse-Mesh hybrid structural stress method for fatigue evaluation of Spot-Welded structures.” International Journal of Fatigue 164 (2022): 107109.)
Method 2: Apply a simultaneous equation method (see Zhang et al. 2022) by transforming nodal force/moments with respect to the virtual nodes to line forces/moments. The structural stress around a joint can be calculated using line force divided by plate thickness and line moment by plate section modulus.

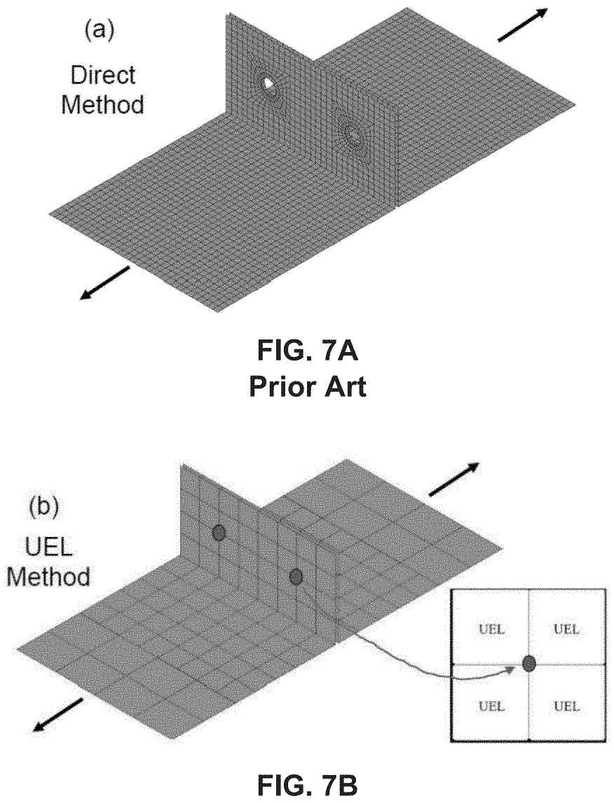

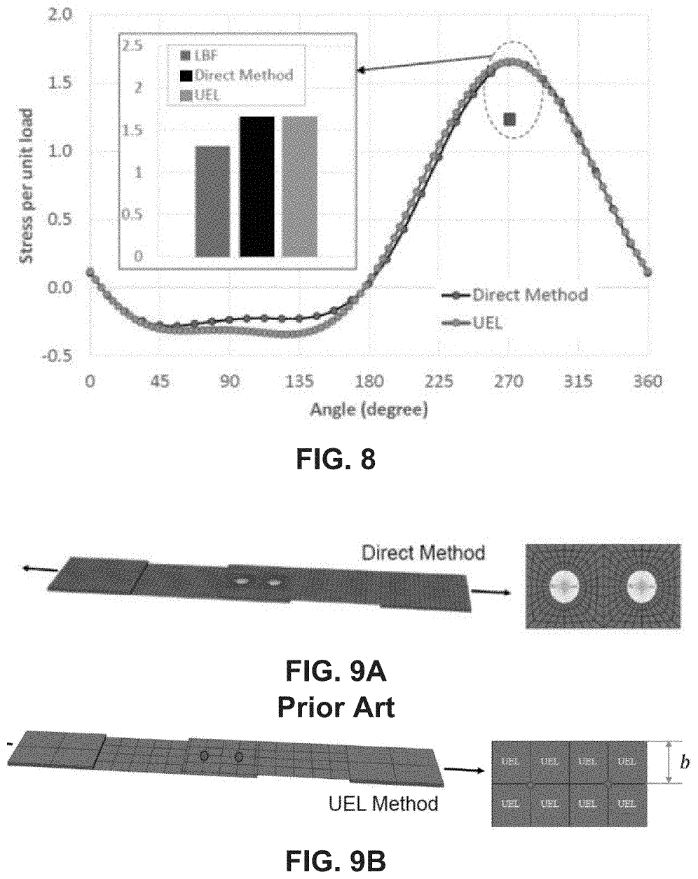

The effectiveness and simplicity of the UEL model method have been proven with numerous spot-welded components under various loading conditions, as shown in FIGS. 7A and 7B. FIG. 7A is an illustration of a two spot joint according to a direct method. FIG. 7B is an illustration of a two spot joint modeled according to a UEL method. FIG. 8 is a first comparison graph of the stress per unit load vs angle (degree) according to a direct stress test method, the UEL method according to the principles of the present disclosure and a conventional “LBF” method used in commercial computer aided engineering software. The correct solution (labeled as “Direct Method” using the rather elaborate joint representation scheme is obtained by the most advanced mesh-insensitive method (Dong, P., J. K. Hong, D. A. Osage, D. J. Dewees, and M. Prager. “The master SN curve method an implementation for fatigue evaluation of welded components in the ASME B&PV Code, Section VIII, Division 2 and API 579-1/ASME FFS-1.” Welding Research Council Bulletin 523 (2010).) which is not suited for modeling a large number of spot joints in complex structures. The solutions using the UEL technique in all cases show no significant deviations from the reference solutions. All other solution techniques available in literature and commercial Finite Element codes are not capable of providing a reasonable solution.

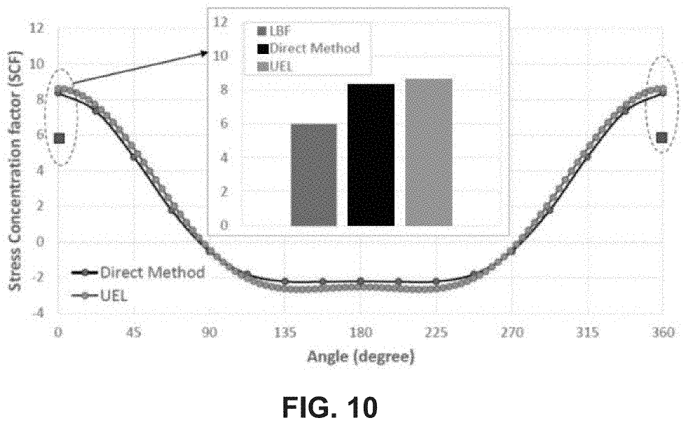

As a further validation technique, FIG. 9A is an illustration of a two spot joint in lap shear specimens according to a direct method. FIG. 9B is an illustration of a two spot joint in lap shear specimens according to a UEL method. FIG. 10 is a second comparison graph of the stress concentration factor (SCF) vs angle (degree) of the lap shear specimens according to a direct stress test method, the UEL method according to the principles of the present disclosure and a conventional “LBF” method used in commercial computer aided engineering software. Again, the solutions using the UEL technique in all cases show no significant deviations from the reference “direct method” solutions.

2. Seam-Welded Joint Modeling

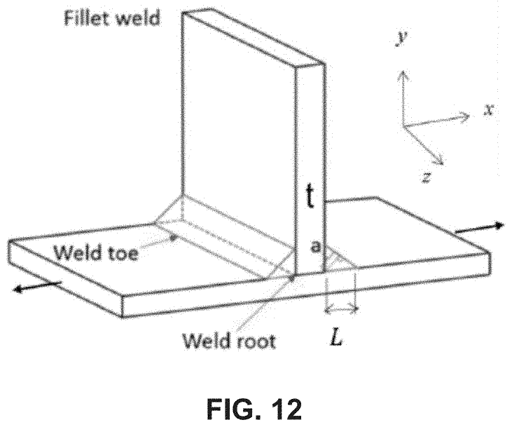

The UEL technique described above can be adapted for modeling seam joints, e.g., those by fusion welding processes, e.g., laser beam welding (LBW), metal inert gas (MIG) or other solid-state welding processes, e.g., friction-based welding or bonding, including friction stir welding (FSW), etc. FIGS. 11A and 11B are schematic representations of the development of a seam weld model using UEL's from an existing explicit parallel seam weld joint modeling technique using coarse-mesh/high fidelity computer aided design durability evaluation of automotive structures. Similarly, FIG. 12 is a schematic illustration of an existing explicit T-joint seam weld modeling technique using coarse-mesh/high fidelity computer aided design durability evaluation of automotive structures and FIGS. 13A and 13B are schematic representations of a T-joint seam weld modeling using explicit filet weld representation and using UELs, respectively. FIG. 14 is an illustration of the virtual node of a conventional seam weld joint modeling technique with imposed seam joint membrane constraints to provide a virtual node of a UEL node according to the principles of the present disclosure.

The decomposition of the shell element stiffness matrix is as follows;

$${k}_{e} = [ \begin{matrix}{k}_{11}^{m} & 0 & 0 & {k}_{21}^{m} & 0 & 0 & {k}_{13}^{m} & 0 & 0 & {k}_{14}^{m} & 0 & 0 \\ 0 & {k}_{11}^{b} & 0 & 0 & {k}_{12}^{b} & 0 & 0 & {k}_{13}^{b} & 0 & 0 & {k}_{14}^{b} & 0 \\ 0 & 0 & 0 & 0 & 0 & 0 & 0 & 0 & 0 & 0 & 0 & 0 \\ {k}_{21}^{m} & 0 & 0 & {k}_{22}^{m} & 0 & 0 & {k}_{23}^{m} & 0 & 0 & {k}_{24}^{m} & 0 & 0 \\ 0 & {k}_{21}^{b} & 0 & 0 & {k}_{22}^{b} & 0 & 0 & {k}_{23}^{b} & 0 & 0 & {k}_{24}^{b} & 0 \\ 0 & 0 & 0 & 0 & 0 & 0 & 0 & 0 & 0 & 0 & 0 & 0 \\ {k}_{31}^{m} & 0 & 0 & {k}_{32}^{m} & 0 & 0 & {k}_{33}^{m} & 0 & 0 & {k}_{34}^{m} & 0 & 0 \\ 0 & {k}_{31}^{b} & 0 & 0 & {k}_{32}^{b} & 0 & 0 & {k}_{33}^{b} & 0 & 0 & {k}_{34}^{b} & 0 \\ 0 & 0 & 0 & 0 & 0 & 0 & 0 & 0 & 0 & 0 & 0 & 0 \\ {k}_{41}^{m} & 0 & 0 & {k}_{42}^{m} & 0 & 0 & {k}_{43}^{m} & 0 & 0 & {k}_{44}^{m} & 0 & 0 \\ 0 & {k}_{41}^{b} & 0 & 0 & {k}_{42}^{b} & 0 & 0 & {k}_{43}^{b} & 0 & 0 & {k}_{44}^{b} & 0 \\ 0 & 0 & 0 & 0 & 0 & 0 & 0 & 0 & 0 & 0 & 0 & 0\end{matrix} ] \qquad ( 98 )$$

With the membrane element being expressed by:

$${k}_{e}^{m} = [ \begin{matrix}{k}_{11}^{m} {k}_{12}^{m} {k}_{13}^{m} {k}_{14}^{m} \\ {k}_{21}^{m} {k}_{22}^{m} {k}_{23}^{m} {k}_{24}^{m} \\ {k}_{31}^{m} {k}_{32}^{m} {k}_{33}^{m} {k}_{34}^{m} \\ {k}_{41}^{m} {k}_{42}^{m} {k}_{43}^{m} {k}_{44}^{m}\end{matrix} ] \qquad ( 99 )$$

And the plate element being expressed by:

$${k}_{e}^{b} = [ \begin{matrix}{k}_{11}^{b} {k}_{12}^{b} {k}_{13}^{b} {k}_{14}^{b} \\ {k}_{21}^{b} {k}_{22}^{b} {k}_{23}^{b} {k}_{24}^{b} \\ {k}_{31}^{b} {k}_{32}^{b} {k}_{33}^{b} {k}_{34}^{b} \\ {k}_{41}^{b} {k}_{42}^{b} {k}_{43}^{b} {k}_{44}^{b}\end{matrix} ] \qquad ( 100 )$$

Imposing seam joint membrane constraints requires assembly of the two membrane element stiffness matrix and applying the constraint conditions including the rigid kinematic relationships:

Uₓ₅=Uₓ₁

U_{y5}=U_{y1}

Uₓ₆=Uₓ₂

U_{y6}=U_{y2}

The formulation further includes applying the force/moment equilibrium equations:

F_{x1,UEL}=Fₓ₁+Fₓ₅ (101)

F_{y1,UEL}=F_{y1}+F_{y5} (102)

F_{x2,UEL}=Fₓ₂+Fₓ₆ (103)

F_{y2,UEL}=F_{y2}+F_{y6} (104)

The formulations also includes imposing seam weld/joint constraints (or “rigid inclusion” constraints) at nodes 5 and 6 on the UEL level further includes the equations:

URₓ₅=URₓ₁ (105)

URₓ₆=URₓ₂ (106)

UR_{y5}=UR_{y1} (107)

UR_{y6}=UR_{y2} (108)

Uₓ₅=Uₓ₁+L·UR_{z1} (109)

Uₓ₆=Uₓ₂+L·UR_{z2} (110)

F_{z1,UEL}=F_{z1}+F_{z5} (111)

F_{z2,UEL}=F_{z2}+F_{z6} (112)

M_{y1,UEL}=M_{y1}+M_{y5} (113)

M_{y2,UEL}=M_{y2}+M_{y6} (114)

M_{x1,UEL}=Mₓ₁+Mₓ₅ (115)

M_{x2,UEL}=Mₓ₂+Mₓ₆ (116)

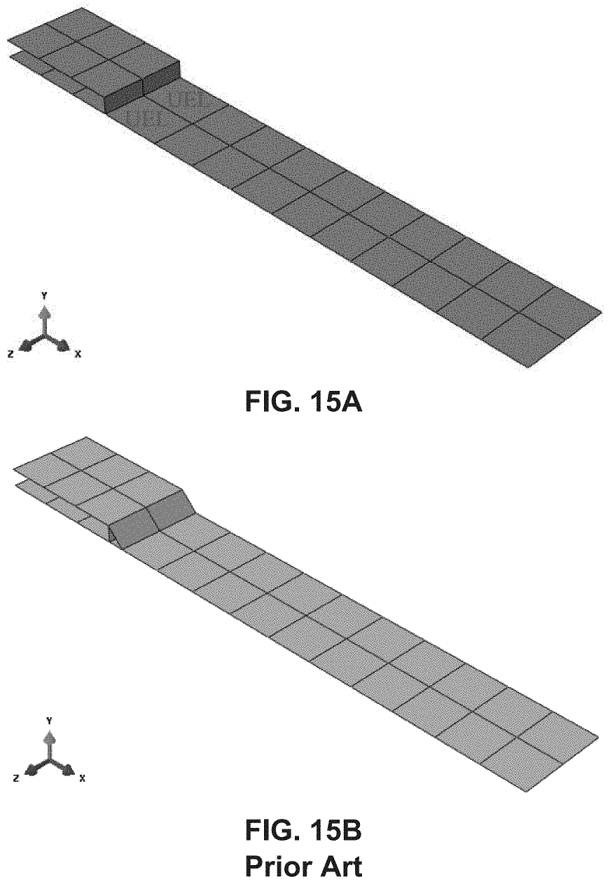

FIG. 15A is an illustration of a lap filet weld joint according to a UEL method. FIG. 15B is an illustration of a lap filet weld joint according to a conventional method. The stress calculated as a validation of the UEL method provided a stress calculation at the weld toe of 1.29 and a stress calculation using the explicit seam joint modeling using Verity™ of 1.27.

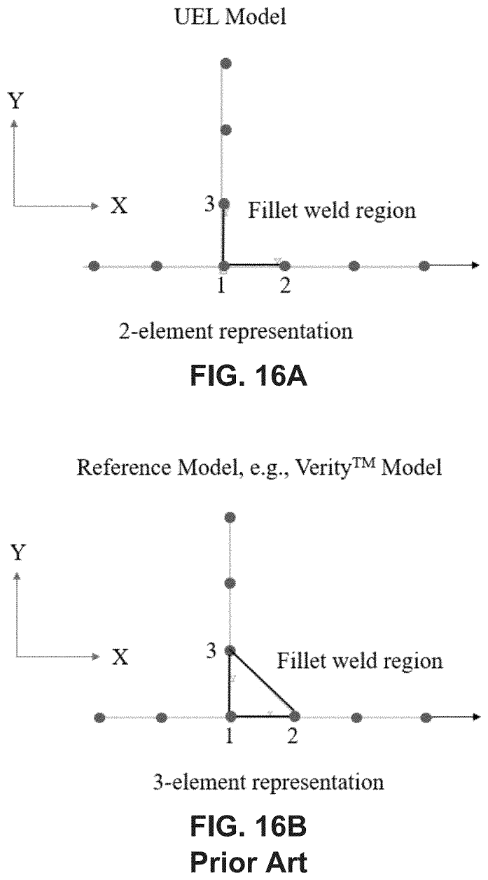

FIG. 16A is a two-element representation of T-filet weld joint according to a UEL method imposing seam weld/joint constraints including a equivalent rotation constraints in two-dimensional cross-section and FIG. 16B is a three-element representation of a T-filet weld joint according to a conventional method. FIGS. 16A and 16B serve as side-views to highlight the local fillet weld region of FIGS. 13A and 13B. The UEL model used is a closed form analytical formulation for achieving the same rotational stiffness among nodes 1, 2 and 3. The three-element model has a stiffness matrix related to nodes 1, 2 and 3 as follows:

$${K}_{Global} = [ \begin{matrix}\frac{{A}_{12} E}{{L}_{12}} + \frac{12 {EI}_{13}}{{L}_{13}^{3}} & 0 & \frac{- 6 {EI}_{13}}{{L}_{13}^{2}} & \frac{- {A}_{12} E}{{L}_{12}} \\ 0 & \frac{{A}_{13} E}{{L}_{13}} + \frac{12 {EI}_{12}}{{L}_{12}^{3}} & \frac{6 {EI}_{12}}{{L}_{12}^{2}} & 0 \\ \frac{- 6 {EI}_{13}}{{L}_{13}^{2}} & \frac{6 {EI}_{12}}{{L}_{12}^{2}} & \frac{4 {EI}_{12}}{{L}_{12}} + \frac{4 {EI}_{12}}{{L}_{13}} & 0 \\ \frac{- {A}_{12} E}{{L}_{12}} & 0 & 0 & \frac{{A}_{12} E}{{L}_{12}} + \frac{{A}_{23} E}{2 {L}_{23}} + \frac{6 {EI}_{23}}{{L}_{23}^{3}} \\ 0 & \frac{- 12 {EI}_{12}}{{L}_{12}^{3}} & - \frac{6 {EI}_{12}}{{L}_{12}^{2}} & \frac{6 {EI}_{23}}{{L}_{23}^{2}} - \frac{{A}_{23} E}{2 {L}_{23}} \\ 0 & \frac{6 {EI}_{12}}{{L}_{12}^{2}} & \frac{2 {EI}_{12}}{{L}_{12}} & \frac{- 3 \sqrt{2} {EI}_{23}}{{L}_{23}^{2}} \\ \frac{- 12 {EI}_{13}}{{L}_{13}^{3}} & 0 & \frac{6 {EI}_{13}}{{L}_{13}^{2}} & \frac{- {A}_{23} E}{2 {L}_{23}} - \frac{6 {EI}_{23}}{{L}_{23}^{3}} \\ 0 & \frac{- {A}_{13} E}{{L}_{13}} & 0 & \frac{{A}_{23} E}{2 {L}_{23}} - \frac{6 {EI}_{23}}{{L}_{23}^{3}} \\ \frac{- 6 {EI}_{13}}{{L}_{13}^{2}} & 0 & \frac{2 {EI}_{13}}{{L}_{13}} & \frac{- 3 \sqrt{2} {EI}_{23}}{{L}_{23}^{2}}\end{matrix} \qquad ( 117 )$$

$${\begin{matrix}0 & 0 & \frac{- 12 {EI}_{13}}{{L}_{13}^{3}} & 0 & - \frac{6 {EI}_{13}}{{L}_{13}^{2}} \\ \frac{- 12 {EI}_{12}}{{L}_{12}^{3}} & \frac{6 {EI}_{12}}{{L}_{12}^{2}} & 0 & \frac{- {A}_{13} E}{{L}_{13}} & 0 \\ \frac{- 6 {EI}_{12}}{{L}_{12}^{2}} & \frac{2 {EI}_{12}}{{L}_{12}} & \frac{6 {EI}_{13}}{{L}_{13}^{2}} & 0 & \frac{2 {EI}_{13}}{{L}_{`3}} \\ \frac{6 {EI}_{23}}{{L}_{23}^{2}} - \frac{{A}_{23} E}{2 {L}_{23}} & \frac{- 3 \sqrt{2} {EI}_{23}}{{L}_{23}^{2}} & \frac{- {A}_{23} E}{2 {L}_{23}} - \frac{6 {EI}_{23}}{{L}_{23}^{3}} & \frac{{A}_{23} E}{2 {L}_{23}} - \frac{6 {EI}_{23}}{{L}_{23}^{3}} & \frac{- 3 \sqrt{2} {EI}_{23}}{{L}_{23}^{2}} \\ \frac{{A}_{23} E}{2 {L}_{23}} + \frac{12 {EI}_{12}}{{L}_{12}^{3}} + \frac{6 {EI}_{23}}{{L}_{23}^{3}} & \frac{- 6 {EI}_{12}}{{L}_{12}^{2}} - \frac{3 \sqrt{2} {EI}_{23}}{{L}_{23}^{2}} & \frac{{A}_{23} E}{2 {L}_{23}} - \frac{6 {EI}_{23}}{{L}_{23}^{3}} & \frac{- {A}_{23} E}{2 {L}_{23}} - \frac{6 {EI}_{23}}{{L}_{23}^{3}} & \frac{- 3 \sqrt{2} {EI}_{23}}{{L}_{23}^{2}} \\ \frac{- 6 {EI}_{12}}{{L}_{12}^{2}} - \frac{3 \sqrt{2} {EI}_{23}}{{L}_{23}^{2}} & \frac{4 {EI}_{12}}{{L}_{12}} + \frac{4 {EI}_{23}}{{L}_{23}} & \frac{3 \sqrt{2} {EI}_{23}}{{L}_{23}^{2}} & \frac{3 \sqrt{2} {EI}_{23}}{{L}_{23}^{2}} & \frac{2 {EI}_{23}}{{L}_{23}} \\ \frac{{A}_{23} E}{2 {L}_{23}} - \frac{6 {EI}_{23}}{{L}_{23}^{3}} & \frac{3 \sqrt{2} {EI}_{23}}{{L}_{23}^{2}} & \frac{{A}_{23} E}{2 {L}_{13}} + \frac{12 {EI}_{13}}{{L}_{13}^{3}} + \frac{6 {EI}_{23}}{{L}_{23}^{3}} & \frac{6 {EI}_{23}}{{L}_{23}^{2}} - \frac{{A}_{23} E}{2 {L}_{13}} & \frac{6 {EI}_{13}}{{L}_{13}^{2}} + \frac{3 \sqrt{2} {EI}_{23}}{{L}_{23}^{2}} \\ \frac{- {A}_{23} E}{2 {L}_{23}} - \frac{6 {EI}_{23}}{{L}_{23}^{3}} & \frac{3 \sqrt{2} {EI}_{23}}{{L}_{23}^{2}} & \frac{6 {EI}_{23}}{{L}_{23}^{2}} - \frac{{A}_{23} E}{2 {L}_{13}} & \frac{{A}_{13} E}{{L}_{13}} + \frac{{A}_{23} E}{2 {L}_{23}} + \frac{6 {EI}_{23}}{{L}_{23}^{3}} & \frac{3 \sqrt{2} {EI}_{23}}{{L}_{23}^{2}} \\ \frac{- 3 \sqrt{2} {EI}_{23}}{{L}_{23}^{2}} & \frac{2 {EI}_{13}}{{L}_{13}} & \frac{6 {EI}_{13}}{{L}_{13}^{2}} + \frac{3 \sqrt{2} {EI}_{23}}{{L}_{23}^{2}} & \frac{3 \sqrt{2} {EI}_{23}}{{L}_{23}^{2}} & \frac{4 {EI}_{12}}{{L}_{12}} + \frac{4 {EI}_{12}}{{L}_{13}}\end{matrix} ]}_{9 \times 9}$$

where E is material Young's modulus, Aᵢⱼ is cross-section area of beam i-j and Iᵢⱼ is second moment of inertial of beam i-j and Lᵢⱼ is beam element size of beam i-j.

The two-element UEL model of the stiffness matrix related to nodes 1, 2 and 3 is as follows:

$$\begin{matrix}\begin{matrix}\begin{matrix}\begin{matrix}\begin{matrix}\begin{matrix}\begin{matrix}\begin{matrix}{F}_{1 x} \\ {F}_{1 y}\end{matrix} \\ {M}_{1}\end{matrix} \\ {F}_{2 x}\end{matrix} \\ {F}_{2 y}\end{matrix} \\ {M}_{2}\end{matrix} \\ {F}_{3 x}\end{matrix} \\ {F}_{3 y}\end{matrix} \\ {M}_{3}\end{matrix} K \text{?} = [ \text{?} ]$$

$$\text{?} \text{indicates text missing or illegible when filed}$$

Where k₁ and k₂ are solved analytically by imposing equivalent stiffnes constraints as follows

$$\begin{matrix}( 119 - 121 ) & \\ \begin{matrix} & 2 - element model ( UEL ) & 3 - element model & & \\ Node 1 & \frac{4 {EI}_{12}^{′}}{{L}_{12}} + \frac{4 {EI}_{13}^{′}}{{L}_{23}} = & \frac{4 {EI}_{12}}{{L}_{12}} + \frac{4 {EI}_{13}}{{L}_{13}} & & \\ Node 2 & \frac{4 {EI}_{12}^{′}}{{L}_{12}} + {k}_{1} = & \frac{4 {EI}_{12}}{{L}_{12}} + \frac{4 {EI}_{23}}{{L}_{23}} & & \\ Node 3 & \frac{4 {EI}_{13}^{′}}{{L}_{13}} + {k}_{2} = & \frac{4 {EI}_{13}}{{L}_{13}} + \frac{4 {EI}_{23}}{{L}_{23}} & & \end{matrix} \begin{matrix}\begin{matrix}\begin{matrix}\begin{matrix}\begin{matrix}\begin{matrix}\begin{matrix} \\ ( 1 )\end{matrix} \\ \end{matrix} \\ \end{matrix} \\ ( 2 )\end{matrix} \\ \end{matrix} \\ \end{matrix} \\ ( 3 )\end{matrix} & \end{matrix}$$

The equation (119) for Node 1 is analytically solved for 2-elements' equivalent thickness tₑ. where tₑ=t for simplicity such that I₁₂′=I₁₂ and I₁₃′=I₁₃ and the equation for Node 1 is satisfied automatically. Solving the equations (120-121) for Node 2 and Node 3 for k₁ and k₂, e.g.,

$${k}_{1} = {k}_{2} , = \frac{4 E \frac{{bt}^{3}}{12}}{L} = \frac{{Ebt}^{3}}{3 L} [ {N}^{★} mm / rad ] \qquad ( 122 )$$

Where b and L represent element sizes along and perpendicular to the weld line, respectively, and t is the thickness of the shell element represented by UEL.

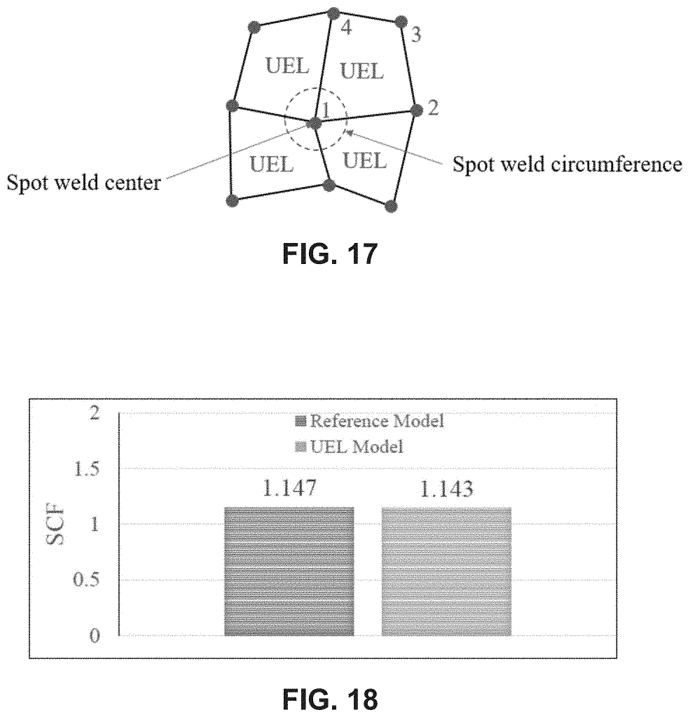

In commercial software, the shape of the element for the UEL method can be arbitrary. For example, FIG. 17 is an illustration of an arbitrary shaped node element according to the UEL method. Using a finite element model shape function, the spatial coordinate of the weld and surrounding nodes are adopted.

The spatial coordinate of the weld, the material properties of the plate thickness and the type weld can be input to the commercial modeling software along with the UEL model as shown in FIG. 6. The finite element analysis software outputs the stress around the weld for fatigue life calculations.

FIG. 18 is a comparison bar graph of the of the stress concentration factor (SCF) of the T-fillet-welded component according to a conventional method and according to a UEL method according to the principles of the present disclosure. The reference model provided a stress concentration factor of 1.147 and the UEL model very accurately provided a stress concentration factor of 1.143.

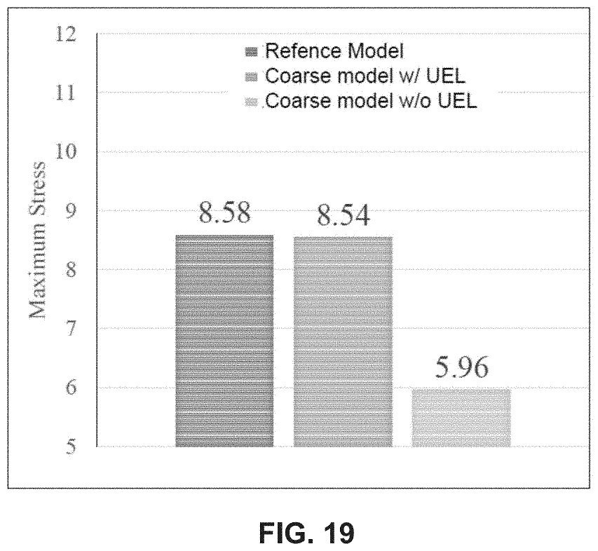

FIG. 19 is a validation bar graph of the of the maximum stress of the T-fillet welded component according to a conventional method, according to a course model with the UEL method according to the principles of the present disclosure and with a course model without the UEL method. The reference model provided a maximum stress of 8.58, the UEL model very accurately provided a maximum stress of 8.54 and the coarse model without the UEL provided a maximum stress of 5.96.

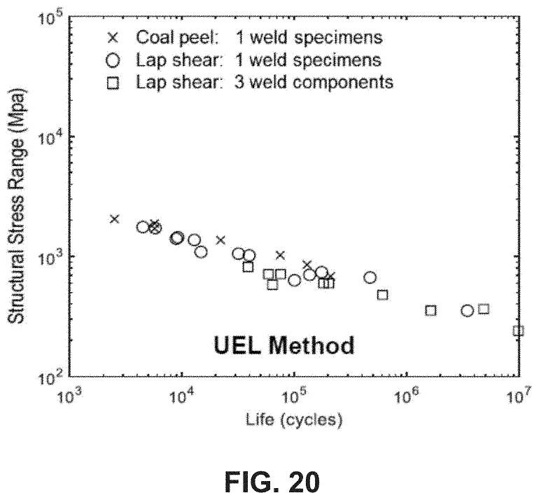

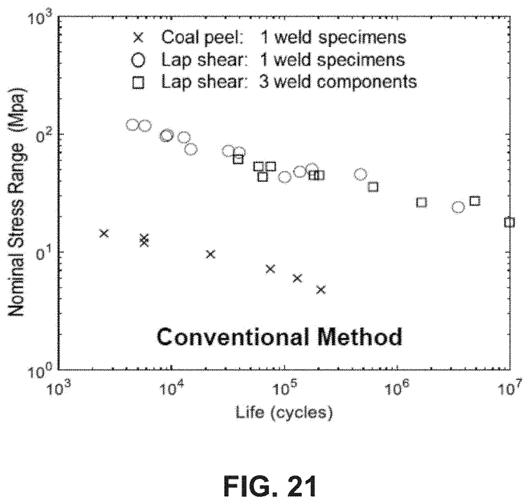

FIG. 20 is a graph demonstrating fatigue life predictability with structural stress range (MPa) vs. Life (cycles) for the UEL coarse mesh finite element modeling by consolidating different specimen types into a narrow band and FIG. 21 is a graph demonstrating the inability of fatigue life prediction using conventional methods, e.g., nominal stress range (MPa) vs. Life (cycles), in which the same test data shown in FIG. 20 scatter significantly. The UEL method provides a unified presentation of fatigue test data regardless specimen types, the number of welds present, and loading modes, etc., therefore offer fatigue life predictability for structural durability design and evaluation. The validations of the UEL technique for two fillet-welded lap joint and T joint are summarized, by comparing the stress values calculated against those by means of the mesh-insensitive structural stress method (Dong, 2010) which requires explicit fillet weld representation. The UEL based results are in good agreement with those obtained by using FE models with explicit seam weld representation in FE models.

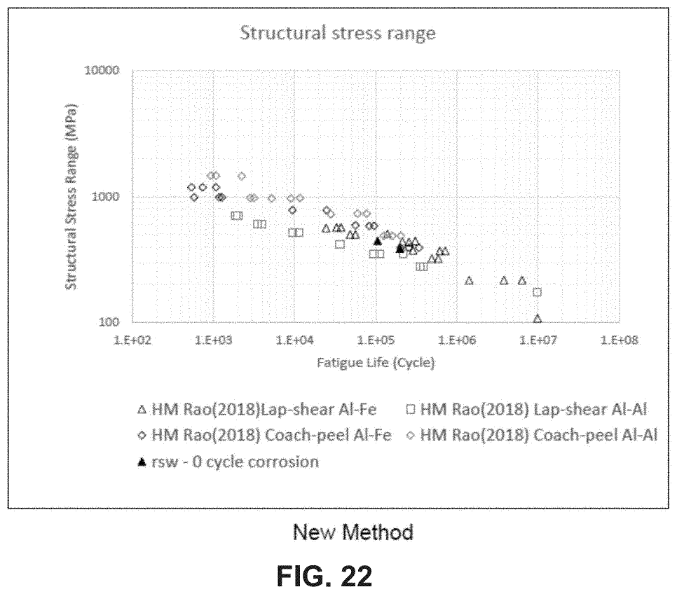

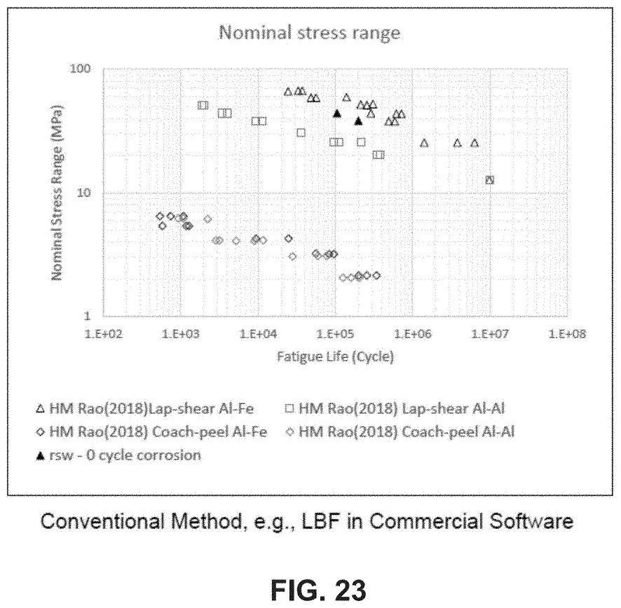

FIG. 22 is a graph demonstrating fatigue life predictability in dissimilar material welds e.g. aluminum to steel with structural stress range (MPa) vs. Life (cycles) for the UEL coarse mesh finite element modeling and FIG. 23 is a graph demonstrating fatigue life predictability in dissimilar material welds e.g. aluminum to steel with structural stress range (MPa) vs. Life (cycles) for the conventional modeling method. Again, the UEL model provided a unified and consistent representation of fatigue test data for dissimilar metal joints while none of the existing methods are not capable of doing so.

3. Fatigue Life Predictability Using UEL Technique

The structural stress so calculated using the developed UEL technique have been proven to consolidate fatigue test data into a narrow band without any empirical parameters being introduced, regardless of joint types, loading conditions, and the actual number of welds involved in a component. This implies the UEL technique offers both data transferability (i.e., no need to test a large variation of joint types, specimen types, loading conditions, component geometries, etc.) and life predictability using simple joint test data to predict fatigue life of complex structures containing many welds.

The UEL technique is employed with commercial finite element software to confirm that a structure such as a vehicle body or frame meets structural stress requirements. If the result of a particular body design is determined not to meet the structural stress requirements, the number of locations of the spot and/or seam welds can be modified and confirmed to meet the structural stress requirements and re-tested using the UEL technique. Once a design is determined to meet the structural stress requirement, the structure can then be manufactured with the spot and/or seam weld arrangement as designed and tested using the UEL technique.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

What is claimed is:

1. A user-element (UEL) method for enabling coarse-mesh/high-fidelity Computer-Aided Engineering (CAE) durability evaluation of spot-joined structures, the method comprising:
providing a course mesh joint representation of the spot-joined structure;
imposing spot joint constraints at virtual nodes of the course mesh joint representation;
imposing membrane deformation joint constraints on the course mesh joint representation;
imposing final membrane stiffness matrix expressed in closed form;
imposing bending deformation joint constraints on the course mesh joint representation;
analytically reducing a combined stiffness matrix of 36×36 to a UEL element stiffness matrix of 24×24;
coding in computer programming language the analytically derived stiffness matrix (24×24) into a UEL subroutine for interfacing with CAE code; and
outputting structural stresses around a joint for durability or fatigue life prediction purposes.

2. The user element method according to claim 1, further comprising determining whether the spot-joined structure meets required durability or fatigue life criteria and manufacturing the spot joined structure.

3. The user element method according to claim 1, wherein the spot joint constraints include the relationships Node 1: (x₁,y₁)=(0,a); Node 2:
$$( {x}_{2} , {y}_{2} ) = ( \frac{\sqrt{2} a}{2} , \frac{\sqrt{2} a}{2} ) ;$$
Node 3: (x₃,y₃)=(b,b); Node 4: (x₄,y₄)=(0,b), where a=the joint weld nugget radius and b=element size.

4. The user element method according to claim 1, wherein the membrane deformation joint constraints include rigid kinematic relationships.

5. The user element method according to claim 1, wherein the membrane deformation joint constraints include force equilibrium equations.

6. The user element method according to claim 5, wherein the force equilibrium equations include Fₓ₇=Fₓ₁+Fₓ₂+Fₓ₅; and F_{y7}=F_{y1}+F_{y2}+F_{y5}.

7. A user-element (UEL) method for enabling coarse-mesh/high-fidelity Computer-Aided Engineering (CAE) durability evaluation of seam-joined structures, the method comprising:
providing a course mesh joint representation of the seam-joined structure;
imposing seam joint membrane constraints at virtual nodes of the course mesh joint representation;
imposing seam weld joint constraints on the course meh joint representation;
imposing shell element stiffness matrix expressed in closed form;
analytically reducing a combined stiffness matrix of 36×36 to a UEL element stiffness matrix of 24×24;
coding in computer programming language the analytically derived stiffness matrix (24×24) into a UEL subroutine for interfacing with CAE code; and
outputting structural stresses around a seam joint for durability or fatigue life prediction purposes.

8. The user element method according to claim 7, further comprising determining whether the spot-joined structure meets required durability or fatigue life criteria and manufacturing the spot joined structure.

9. The user element method according to claim 7, wherein the seam joint membrane constraints include rigid kinematic relationships.

10. The user element method according to claim 7, wherein the seam joint membrane constraints include force/moment equilibrium equations.

11. The user element method according to claim 7, where the seam weld joint constraints include rigid inclusion constraints.
